(19) United States
(12) Patent Application Publication
(10) Pub. No.: US 2012/0015247 A1
(43) Pub. Date: Jan. 19, 2012

(54) SILICON CRYSTAL BODY AND POWER STORAGE DEVICE USING THE SILICON CRYSTAL BODY

(75) Inventor: Yasunori YOSHIDA, Toyota-shi (JP)

(73) Assignee: SEMICONDUCTOR ENERGY LABORATORY CO., LTD., Atsugi-shi (JP)

(21) Appl. No.: 13/178,635

(22) Filed: Jul. 8, 2011

(30) Foreign Application Priority Data
Jul. 14, 2010 (JP) 2010-159663

(51) Int. Cl. H01M 4/134; C01B 33/02

(52) U.S. Cl. 429/218.1; 423/348

(57) ABSTRACT

It is difficult to obtain discharge capacity as high as the theoretical capacity in the case where silicon is used as a negative electrode active material. Therefore, objects are to provide a negative electrode active material capable of increasing discharge capacity and to provide a high-performance power storage device including the negative electrode active material. As the negative electrode active material with which the objects are achieved, a silicon crystal body including a plurality of crystalline regions is provided. The silicon crystal body has one extension direction. The plurality of crystalline regions have respective crystal orientations that are substantially the same (also referred to as a preferred orientation). The extension direction and the preferred direction are substantially the same.

### BACKGROUND OF THE INVENTION

1. Field of the Invention

The present invention relates to a silicon crystal body and a power storage device using the silicon crystal body.

2. Description of the Related Art

Power storage devices such as lithium ion secondary batteries, lithium ion capacitors, and air cells have been actively developed. The lithium ion secondary batteries in particular have been used in a variety of applications including mobile phones, electric vehicles (EV), and the like. Such lithium ion secondary batteries need to have high energy density, cycle characteristics, and the like and need to be safe in a variety of operation environments.

An electrode for a power storage device is formed by providing an active material on a surface of a current collector. As the active material, a material to/from which ions functioning as carriers can be adsorbed or desorbed, such as carbon or silicon, is used. For example, silicon or phosphorus-doped silicon has a higher theoretical capacity than carbon, and thus is advantageous in increasing the capacity of a power storage device (e.g., Patent Document 1).
[Patent Document 1] Japanese Published Patent Application No. 2001-210315

### SUMMARY OF THE INVENTION

However, even when silicon is used as a negative electrode active material, it is difficult to obtain discharge capacity as high as the theoretical capacity. In view of the above, an object of one embodiment of the present invention is to provide a negative electrode active material capable of increasing discharge capacity. Another object of one embodiment of the present invention is to provide a high-performance power storage device including the negative electrode active material.

The negative electrode active material with which the object of the present invention is achieved includes a silicon crystal body that has one extension direction and includes a plurality of crystalline regions. The plurality of crystalline regions have crystal orientations that are substantially the same as the extension direction of the silicon crystal body.

In other words, one embodiment of the present invention is a silicon crystal body that includes a plurality of crystalline regions. The silicon crystal body has one extension direction. The plurality of crystalline regions have respective crystal orientations that are substantially the same (also referred to as a preferred orientation). The extension direction and the preferred orientation are substantially the same.

In the silicon crystal body, the plurality of crystalline regions have respective crystal orientations that are substantially the same. The crystal orientation may be either of the two orientations, <110> or <211>, depending on the shape of the silicon crystal body.

In other words, another embodiment of the present invention is a silicon crystal body in which the crystal orientations that are substantially the same are expressed as <110> or <211>.

In the silicon crystal body, the crystal orientation <110> that is a preferred orientation of the plurality of crystalline regions and the extension direction of the silicon crystal body are substantially the same. Note that here, “the crystal orientation <110> and the extension direction of the silicon crystal body are substantially the same” means that the angle formed by the crystal orientation <110> and the extension direction of the silicon crystal body is in the range of greater than or equal to 0° and less than or equal to 20°, preferably greater than or equal to 0° and less than or equal to 15°, more preferably greater than or equal to 0° and less than or equal to 10°. Further, in the silicon crystal body, the crystal orientation <211> that is a preferred orientation of the plurality of crystalline regions and the extension direction of the silicon crystal body are substantially the same. Note that here, “the crystal orientation <211> and the extension direction of the silicon crystal body are substantially the same” means that the angle formed by the crystal orientation <211> and the extension direction of the silicon crystal body is in the range of greater than or equal to 0° and less than or equal to 20°, preferably greater than or equal to 0° and less than or equal to 15°, more preferably greater than or equal to 0° and less than or equal to 10°.

In other words, another embodiment of the present invention is a silicon crystal body in which the crystal orientation (the preferred orientation) and the extension direction are substantially the same when the angle formed by the crystal orientation and the extension direction is in the range of greater than or equal to 0° and less than or equal to 20°.

The silicon crystal body including the plurality of crystalline regions has a variety of shapes.

In other words, another embodiment of the present invention is a silicon crystal body that is cylindrical or prismatic. Further, another embodiment of the present invention is a silicon crystal body that is conical or pyramidal.

Moreover, a power storage device in which an electrode is formed using the silicon crystal body can be manufactured. Another embodiment of the present invention is a power storage device that includes at least a pair of electrodes, a separator, and an electrolyte. One of the pair of electrodes is formed using a silicon crystal body including a plurality of crystalline regions. The silicon crystal body has one extension direction. The plurality of crystalline regions have respective crystal orientations that are substantially the same (also referred to as a preferred orientation). The extension direction and the preferred orientation are substantially the same.

Another embodiment of the present invention is a power storage device that includes at least a pair of electrodes, a separator, and an electrolyte. One of the pair of electrodes is formed using the silicon crystal body. The preferred orientation is <110> or <211>.

Another embodiment of the present invention is a power storage device that includes at least a pair of electrodes, a separator, and an electrolyte. One of the pair of electrodes is formed using the silicon crystal body. The crystal orientation and the extension direction are substantially the same when the angle formed by the crystal orientation and the extension direction is in the range of greater than or equal to 0° and less than or equal to 20°, preferably greater than or equal to 0° and less than or equal to 15°, more preferably greater than or equal to 0° and less than or equal to 10°.

Another embodiment of the present invention is a power storage device that includes at least a pair of electrodes, a separator, and an electrolyte. One of the pair of electrodes is formed using the silicon crystal body. The silicon crystal body is cylindrical or prismatic.

Another embodiment of the present invention is a power storage device that includes at least a pair of electrodes, a separator, and an electrolyte. One of the pair of electrodes is formed using the silicon crystal body. The silicon crystal body is conical or pyramidal.

Note that in this specification, the “preferred orientation” refers to one crystal orientation which dominantly exists in the crystal orientations of the plurality of crystalline regions included in the silicon crystal body.

According to one embodiment of the present invention, a negative electrode active material capable of increasing discharge capacity can be provided. In addition, a high-performance power storage device including the negative electrode active material can be provided.

### BRIEF DESCRIPTION OF THE DRAWINGS

FIGS. 1A to 1C are cross-sectional views illustrating structures and a manufacturing method of an electrode of a power storage device.

FIGS. 2A to 2C illustrate a structure of a needle-like protrusion and electron diffraction patterns thereof.

FIGS. 3A to 3C illustrate a structure of the needle-like protrusion and electron diffraction patterns thereof.

FIGS. 4A to 4C illustrate a structure of the needle-like protrusion and electron diffraction patterns thereof.

FIGS. 5A and 5B illustrate electron diffraction patterns of a columnar protrusion.

FIGS. 6A to 6C illustrate a structure of the columnar protrusion and electron diffraction patterns thereof.

FIGS. 7A to 7C illustrate a structure of the columnar protrusion and electron diffraction patterns thereof.

FIG. 8 is a cross-sectional view illustrating a structure of an electrode of a power storage device.

FIGS. 9A and 9B are a plan view and a cross-sectional view illustrating one embodiment of a power storage device.

FIG. 10 is a perspective view illustrating an application mode of a power storage device.

FIGS. 11A and 11B are perspective views illustrating an application mode of a power storage device.

FIG. 12 is a diagram showing a structure of a wireless power feeding system.

FIG. 13 is a diagram showing a structure of a wireless power feeding system.

FIG. 14 is a plane SEM image of an active material layer.

FIGS. 15A and 15B show a cross-sectional TEM image of a silicon crystal body and an electron diffraction pattern thereof.

FIGS. 16A and 16B show a cross-sectional TEM image of the silicon crystal body and an electron diffraction pattern thereof.

FIGS. 17A and 17B show a cross-sectional TEM image of the silicon crystal body and an electron diffraction pattern thereof.

FIGS. 18A and 18B show a cross-sectional TEM image of a silicon crystal body and an electron diffraction pattern thereof.

FIGS. 19A and 19B show a cross-sectional TEM image of the silicon crystal body and an electron diffraction pattern thereof.

FIGS. 20A and 20B show a cross-sectional TEM image of the silicon crystal body and an electron diffraction pattern thereof.

FIG. 21 illustrates a manufacturing method of a secondary battery.

### DETAILED DESCRIPTION OF THE INVENTION

Hereinafter, Embodiments and Example of the present invention will be described in detail with reference to the accompanying drawings. Note that the present invention is not limited to the description below, and it is easily understood by those skilled in the art that a variety of changes and modifications can be made without departing from the spirit and scope of the present invention. Therefore, the invention should not be construed as being limited to the description of Embodiments below. In describing structures of the present invention with reference to the drawings, the same reference numerals are used in common for the same portions in different drawings. The same hatching pattern is applied to similar parts, and the similar parts are not especially denoted by reference numerals in some cases. In addition, an insulating layer is not illustrated in a top view in some cases. Note that the size, the layer thickness, or the region of each structure illustrated in each drawing is exaggerated for clarity in some cases and thus the actual scale is not necessarily limited to the illustrated scale. Therefore, the present invention is not necessarily limited to such scales illustrated in the drawings.

### Embodiment 1

In this embodiment, a silicon crystal body that is one embodiment of the present invention will be described using the case where the silicon crystal body is used for an electrode of a power storage device as an example.

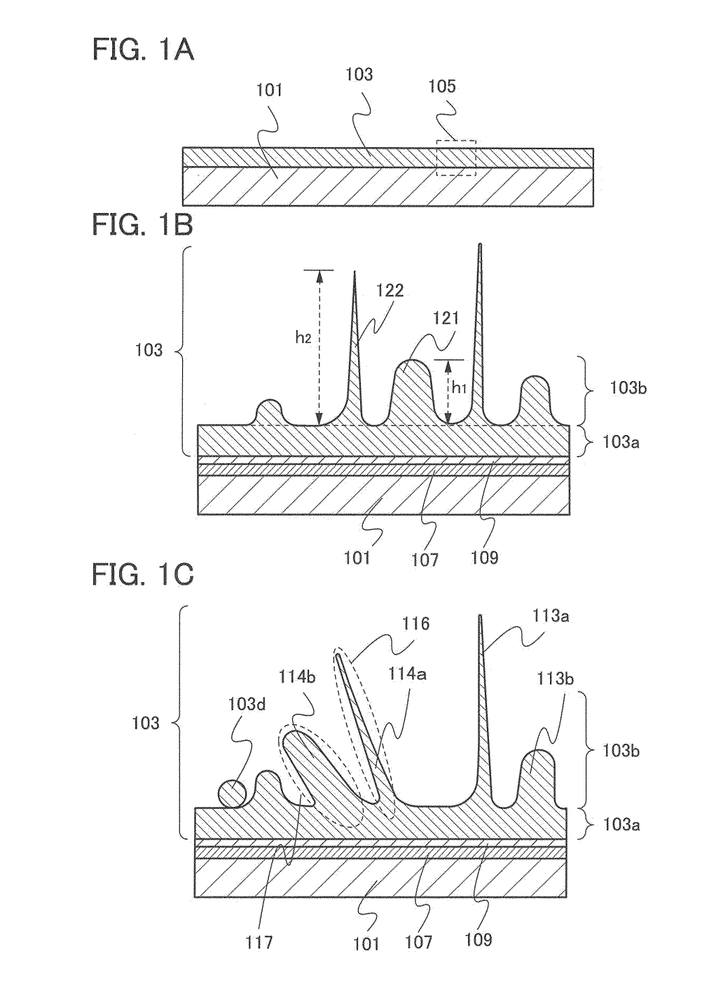

The electrode of the power storage device includes a silicon crystalline layer functioning as an active material layer 103 over a current collector 101 (see FIG. 1A).

FIG. 1B is an enlarged view of the current collector 101 and the active material layer 103 surrounded by a dashed line 105 in FIG. 1A.

The active material layer 103 includes a silicon crystalline region 103a and a whisker-like silicon crystalline region 103b formed over the silicon crystalline region 103a. Note that the interface between the silicon crystalline region 103a and the whisker-like silicon crystalline region 103b is not clear. Therefore, in this specification, the plane that is at the same level as the bottom of the deepest valley of the valleys formed among protrusions in the whisker-like silicon crystalline region 103b and is parallel to the surface of the current collector is regarded as the interface between the silicon crystalline region 103a and the whisker-like silicon crystalline region 103b.

In this specification and the like, a protruded (whisker-like) silicon crystal body is referred to as a whisker-like silicon crystal body. The extension directions (i.e., the directions of axes) of the whisker-like silicon crystal bodies may vary. The extension directions (i.e., the directions of axes) of the whisker-like silicon crystal bodies may be the normal direction to the current collector. The “whisker-like silicon crystal body” in this specification and the like may include a group of whisker-like silicon crystal bodies (a plurality of whisker-like silicon crystal bodies).

The silicon crystalline region 103a covers the current collector 101. In the whisker-like silicon crystalline region 103b, protrusions are dispersed.

The whisker-like silicon crystalline region 103b has a plurality of protrusions including columnar protrusions or needle-like protrusions. The top of the protrusion may be rounded. The diameter of the protrusion is greater than or equal to 50 nm and less than or equal to 10 μm, preferably greater than or equal to 500 nm and less than or equal to 3 μm. In addition, the length along the axis of the protrusion is greater than or equal to 0.5 μm and less than or equal to 1000 μm, preferably greater than or equal to 1 μm and less than or equal to 100 μm.

The columnar protrusion may include a cylindrical protrusion or a prismatic protrusion in its category. In FIG. 1B, a columnar protrusion 121 is projected upward from the silicon crystalline region 103a.

Note that the length h₁ along the axis of the columnar protrusion corresponds to the distance between the top surface (the upper surface) of the protrusion and the silicon crystalline region 103a along the axis running through the center of the top surface of the protrusion. Further, the largest thickness of the whisker-like silicon crystalline region 103b in a portion having the columnar protrusion corresponds to the length of the line which perpendicularly runs from the top surface of the protrusion to the surface of the silicon crystalline region 103a along the axis running through the center of the top surface of the protrusion.

The needle-like protrusion may include a conical protrusion or a pyramidal protrusion in its category. In FIG. 1B, a needle-like protrusion 122 is projected upward from the silicon crystalline region.

Note that the length h₂ along the axis of the needle-like protrusion corresponds to the distance between the top of the protrusion and the silicon crystalline region 103a along the axis running through the center of the top of the protrusion. Further, the largest thickness of the whisker-like silicon crystalline region 103b in a portion having the needle-like protrusion corresponds to the length of the line which perpendicularly runs from the top of the protrusion to the surface of the silicon crystalline region 103a.

Note that the direction in which a protrusion extends from the silicon crystalline region 103a is referred to as a longitudinal direction. The cross section along the longitudinal direction is referred to as a longitudinal cross section. In addition, the cross section along the direction perpendicular to the longitudinal direction is referred to as a transverse cross section.

As in FIG. 1C, the longitudinal directions of the protrusions formed in the whisker-like silicon crystalline region 103b may vary. Note that a mixed layer 107 in FIG. 1C is a mixed layer formed using a metal element contained in the current collector 101 and silicon. A metal oxide layer 109 is a metal oxide layer formed using an oxide of the metal element contained in the current collector 101. The mixed layer 107 and the metal oxide layer 109 will be specifically described later.

Typically, the whisker-like silicon crystalline region 103b includes a first protrusion whose longitudinal direction is substantially the same as the normal direction to the surface of the silicon crystalline region 103a and a second protrusion whose longitudinal direction is different from the normal direction. In FIG. 1C, a needle-like protrusion 113a and a columnar protrusion 113b are provided as the first protrusions and a needle-like protrusion 114a and a columnar protrusion 114b are provided as the second protrusions.

The longitudinal directions of the protrusions vary; therefore, as in FIG. 1C, a transverse cross-sectional shape of a protrusion like a region 103d exists as well as the longitudinal cross-sectional shapes of the protrusions in the cross-section of the whisker-like silicon crystalline region 103b. The region 103d is circular because it is a transverse cross-sectional shape of a cylindrical protrusion or a conical protrusion. When the protrusion has a prismatic shape or a pyramidal shape, the region 103d is polygonal.

Each of the protrusions in the whisker-like silicon crystalline region 103b includes a plurality of crystalline regions. The plurality of crystalline regions have respective crystal orientations. In particular, a preferred orientation that is one crystal orientation which dominantly exists and the longitudinal direction of the protrusion in the whisker-like silicon crystalline region 103b are substantially the same.

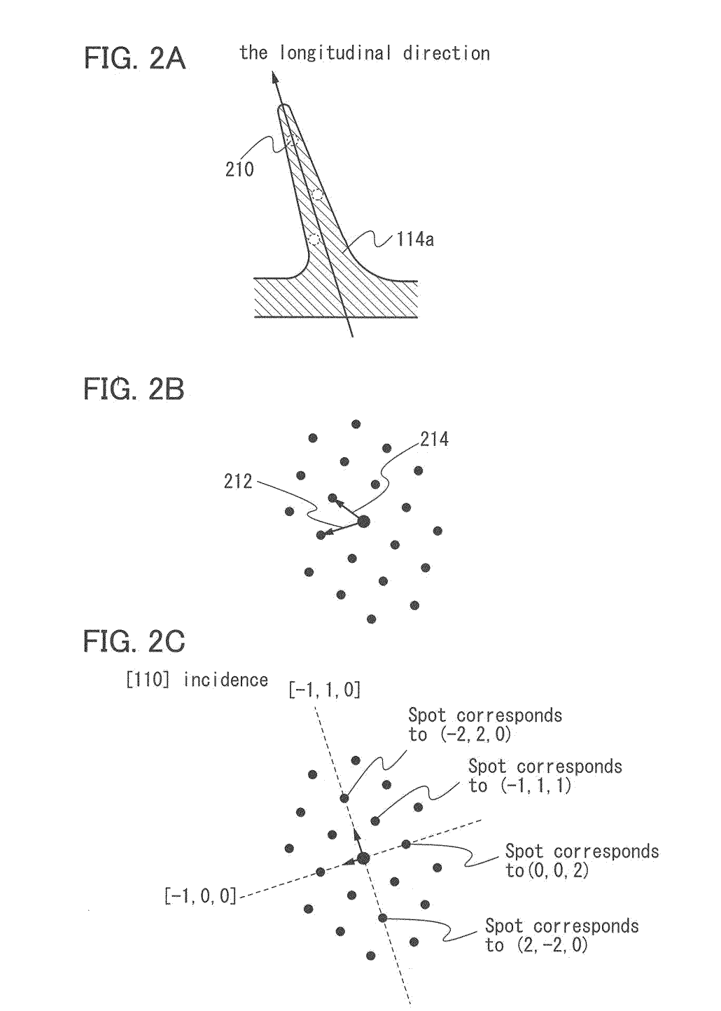

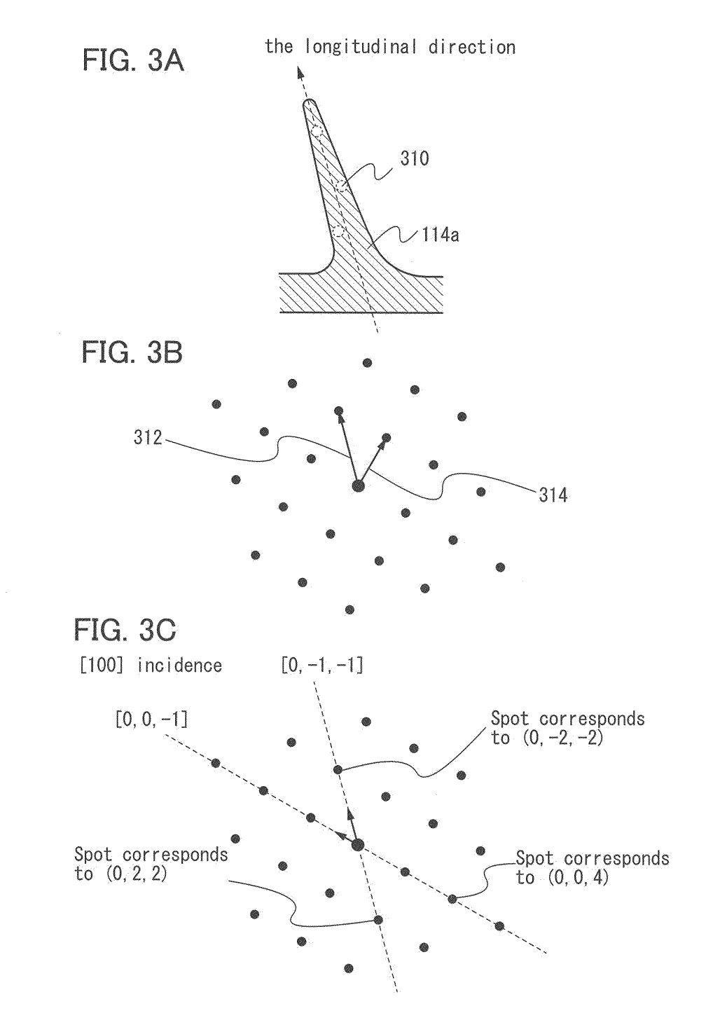

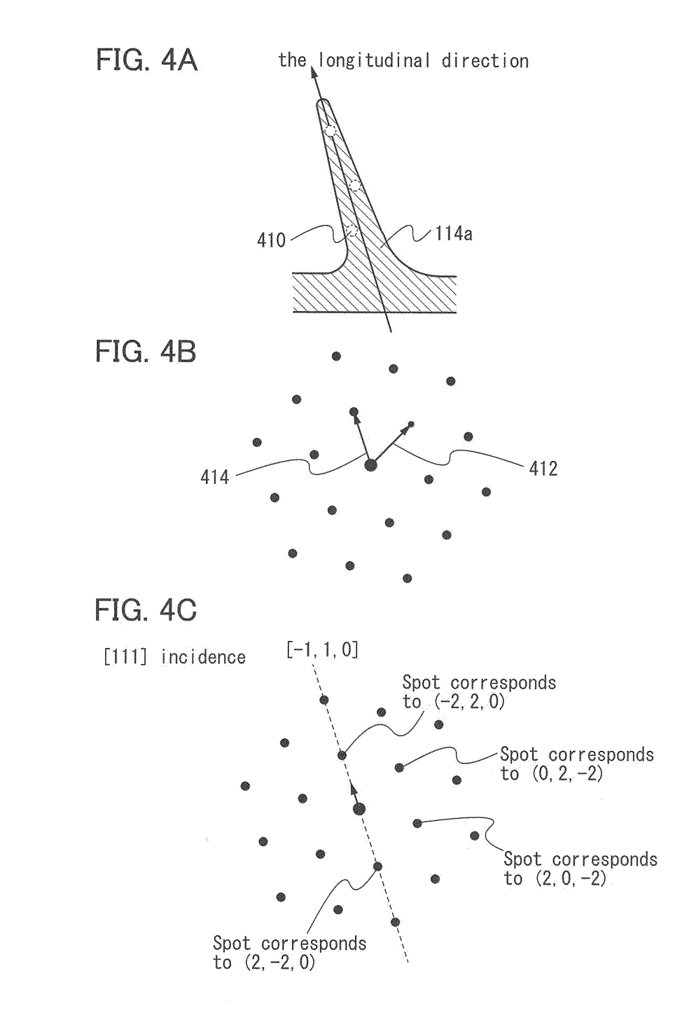

Here, the above characteristics will be described with reference to FIGS. 2A to 2C, FIGS. 3A to 3C, and FIGS. 4A to 4C. FIG. 2A, FIG. 3A, and FIG. 4A are enlarged views of the needle-like protrusion 114a surrounded by a dashed line 116 in FIG. 1C.

The needle-like protrusion 114a in each of FIG. 2A, FIG. 3A, and FIG. 4A include a plurality of crystalline regions having respective crystal orientations. First, a crystalline region 210 that is one of the plurality of crystalline regions having respective crystal orientations will be described.

An arrow in FIG. 2A corresponds to the longitudinal direction of the needle-like protrusion 114a which is a whisker-like silicon crystal body.

FIGS. 2B and 2C are schematic views of electron diffraction patterns in a longitudinal cross section of the crystalline region 210 having one crystal orientation. The diffraction pattern in this embodiment is obtained by a selected area diffraction method. The selected area diffraction method is a method for obtaining a diffraction pattern of an area selected with the use of a selector aperture by irradiation of a sample with parallel electron beams. The selected area diffraction method in this embodiment has a smallest aperture diameter for analysis of 400 nm.

Note that in the schematic views of the electron diffraction patterns in this specification, the contrast density of diffraction spots (black dots), the distance between the diffraction spots, and the like are different from an actual electron diffraction pattern for clarification in some cases. Further, the contrast density of diffraction spots, the distance between the diffraction spots, and the like are different between drawings in this specification in some cases.

Diffraction spots (black dots) in the diffraction patterns in FIGS. 2B and 2C correspond to diffraction from a crystal surface of the crystalline region 210. The silicon crystal body has a diamond crystal structure. Thus, each of the diffraction spots can be indexed by obtaining the ratio between the distance between the transmission electron spot and a diffraction spot and the distance between the transmission electron spot and another diffraction spot, and the angle formed by the straight lines connecting the transmission electron spot and the diffraction spots. Moreover, the crystal orientation of the crystalline region 210 can be identified from the index of each diffraction spot.

In the diffraction pattern from the crystalline region 210, which is shown in FIG. 2B, the vectors from the transmission electron spot to two diffraction spots which are not on one straight line passing through the transmission electron spot are represented by an arrow 212 and an arrow 214. Furthermore, the distances between the transmission electron spot and the two diffraction spots are represented by L₂₁₂ and L₂₁₄. The ratio of the length of the arrow 212 to the length of the arrow 214 (L₂₁₂/L₂₁₄) is about 1.155, and the angle formed by the arrow 212 and the arrow 214 is about 54.74°; therefore, the diffraction pattern from the crystalline region 210, which is shown in FIG. 2B, is a pattern of [110] incidence. The spots in the diffraction pattern can be indexed in consideration of the crystal structure of silicon. As in FIG. 2C, the spots can be indexed to be, for example, (−2,2,0), (2,−2,0), (0,0,2), and (−1,1,1).

In FIG. 2C, the orientation represented by the arrow on the straight line passing through the transmission electron spot, the diffraction spot (−2,2,0), and the diffraction spot (2,−2,0) is [−1,1,0]. In addition, in FIG. 2C, the orientation represented by the arrow on the straight line passing through the transmission electron spot and the diffraction spot (0,0,2) is [−1,0,0].

Next, a crystalline region 310 that is different from the crystalline region 210 in the needle-like protrusion 114a in FIG. 2A will be described (see FIG. 3A).

An arrow in FIG. 3A corresponds to the longitudinal direction of the needle-like protrusion 114a which is a whisker-like silicon crystal body.

FIGS. 3B and 3C are electron diffraction patterns in a longitudinal cross section of the crystalline region 310 having one crystal orientation. This diffraction pattern is obtained by a selected area diffraction method, which is used for analyzing the crystal orientation of the crystalline region 210.

Diffraction spots (black dots) in the diffraction patterns in FIGS. 3B and 3C correspond to diffraction from a crystal surface of the crystalline region 310. In other words, the crystal orientation of the crystalline region 310 can be identified by indexing each diffraction spot.

In the diffraction pattern from the crystalline region 310, which is shown in FIG. 3B, the vectors from the transmission electron spot to two diffraction spots which are not on one straight line passing through the transmission electron spot are represented by an arrow 312 and an arrow 314. Furthermore, the distances between the transmission electron spot and the two diffraction spots are represented by L₃₁₂ and L₃₁₄. The ratio of the length of the arrow 312 to the length of the arrow 314 (L₃₁₂/L₃₁₄) is about 1.414, and the angle formed by the arrow 312 and the arrow 314 is about 45°; therefore, the diffraction pattern from the crystalline region 310, which is shown in FIG. 3B, is a pattern of [100] incidence. The spots in the diffraction pattern can be indexed in consideration of the crystal structure of silicon. As in FIG. 3C, the spots can be indexed to be, for example, (0,2,2), (0,−2,−2), and (0,0,4).

In FIG. 3C, the orientation represented by the arrow on the straight line passing through the transmission electron spot, the diffraction spot (0,2,2), and the diffraction spot (0,−2,−2) is [0,−1,−1]. In addition, in FIG. 3C, the orientation represented by the arrow on the straight line passing through the transmission electron spot and the diffraction spot (0,0,4) is [0,0,−1].

Next, a crystalline region 410 that is different from the crystalline region 210 in the needle-like protrusion 114a in FIG. 2A will be described (see FIG. 4A).

An arrow in FIG. 4A corresponds to the longitudinal direction of the needle-like protrusion 114a which is a whisker-like silicon crystal body.

FIGS. 4B and 4C are electron diffraction patterns in a longitudinal cross section of the crystalline region 410 having one crystal orientation. This diffraction is obtained by a selected area diffraction method, which is used for analyzing the crystal orientation of the crystalline region 210.

Diffraction spots (black dots) in the diffraction patterns in FIGS. 4B and 4C correspond to diffraction from a crystal surface of the crystalline region 410. In other words, the crystal orientation of the crystalline region 410 can be identified by indexing each diffraction spot.

In the diffraction pattern from the crystalline region 410, which is shown in FIG. 4B, the vectors from the transmission electron spot to two diffraction spots which are not on one straight line passing through the transmission electron spot are represented by an arrow 412 and an arrow 414. Furthermore, the distances between the transmission electron spot and the two diffraction spots are represented by L₄₁₂ and L₄₁₄. The length of the arrow 412 and the length of the arrow 414 are equal, and the angle formed by the arrow 412 and the arrow 414 is 60°; therefore, the diffraction pattern from the crystalline region 410, which is shown in FIG. 4B, is a pattern of [111] incidence. The spots in the diffraction pattern can be indexed in consideration of the crystal structure of silicon. As in FIG. 4C, the spots can be indexed to be, for example, (−2,2,0), (2,−2,0), (0,2,−2), and (2,0,−2).

In FIG. 4C, the orientation represented by the arrow on the straight line passing through the transmission electron spot, the diffraction spot (−2,2,0), and the diffraction spot (2,−2,0) is [−1,1,0].

Thus, the crystal orientations of the crystalline region 210, the crystalline region 310, and the crystalline region 410 which are included in the needle-like protrusion 114a which is a whisker-like silicon crystal body are substantially the same by having a crystal orientation <110>. In other words, each crystalline region has a preferred orientation <110>. Note that the crystalline region 210, the crystalline region 310, and the crystalline region 410 are mere examples, and other crystalline regions included in the needle-like protrusion 114a, as well as these crystalline regions, have the preferred orientation <110>.

Furthermore, the longitudinal direction of the needle-like protrusion 114a which is a whisker-like silicon crystal body in FIG. 2A, FIG. 3A, and FIG. 4A is substantially the same as the preferred orientation <110> of the crystalline region 210, the crystalline region 310, and the crystalline region 410. In other words, the longitudinal direction of the needle-like protrusion 114a which is a whisker-like silicon crystal body is substantially the same as <110> which is the preferred orientation of the plurality of crystalline regions included in the needle-like protrusion 114a.

Here, in the diamond structure, the smallest angle of the angles formed by any two of the main crystal orientations <100>, <110>, <111>, <210>, <211>, and <221> is an angle formed by <211> and <221>, which is about 17.72°. Thus, in a polycrystal having the diamond structure, crystal orientations can be regarded as being substantially the same as long as the angle formed by the crystal orientations is approximately less than 20°. In other words, “orientations such as the extension directions of the whisker-like silicon crystal bodies, without limitation to crystal orientations, are substantially the same” means that the angle formed by the orientations is in the range of greater than or equal to 0° and less than 20°, preferably greater than or equal to 0° and less than or equal to 15°, more preferably greater than or equal to 0° and less than or equal to 10°.

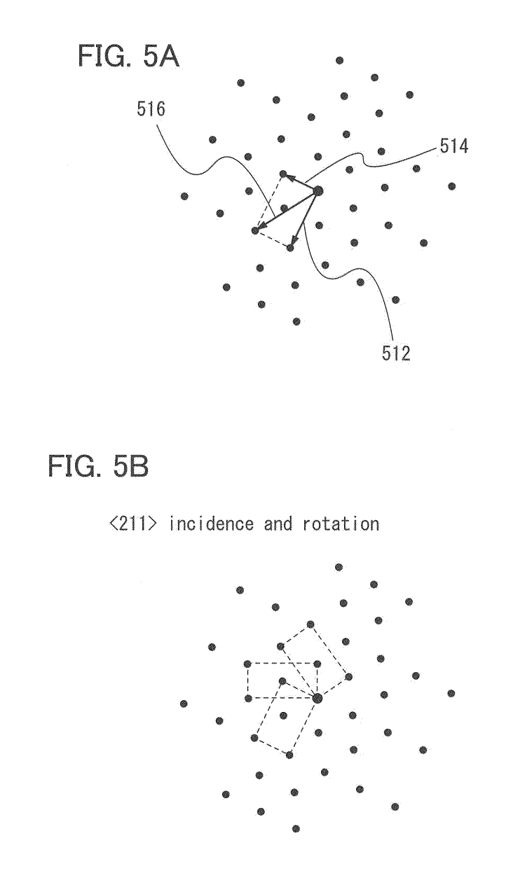

The columnar protrusion 114b in the whisker-like silicon crystalline region 103b, which has a different shape from the needle-like protrusion 114a, also includes a plurality of crystalline regions. The plurality of crystalline regions have respective crystal orientations. In particular, a preferred orientation that is one crystal orientation which dominantly exists is substantially the same as the longitudinal direction of the columnar protrusion 114b as will be described with reference to FIGS. 5A and 5B, FIGS. 6A to 6C, and FIGS. 7A to 7C.

FIGS. 5A and 5B are diffraction patterns obtained by electron diffraction in a transverse cross section of the columnar protrusion 114b in FIG. 1C. The diffraction patterns are also obtained by a selected area diffraction method similar to the one described above.

In the diffraction pattern in FIG. 5A, the vectors from the transmission electron spot to three diffraction spots which are not on one straight line passing through the transmission electron spot are represented by an arrow 512, an arrow 514, and an arrow 516. Furthermore, the distances between the transmission electron spot and the three diffraction spots are represented by L₅₁₂, L₅₁₄, and L₅₁₆. The ratio of the length of the arrow 512 to the length of the arrow 514 (L₅₁₂/L₅₁₄) is about 1.633, the ratio of the length of the arrow 516 to the length of the arrow 514 (L₅₁₆/L₅₁₄) is about 1.915, and the angle formed by the arrow 512 and the arrow 514 is about 90°; therefore, the diffraction pattern in FIG. 5B includes [211] incidence. Further, the observed diffraction pattern includes a plurality of rectangular diffraction patterns which are rotated 60° as shown by dashed lines in FIG. 5B; therefore, the electron diffraction pattern in FIGS. 5A and 5B can be regarded as an electron diffraction pattern in which <211> incidence patterns which are rotated 60° partly overlap. Moreover, FIGS. 5A and 5B indicate that the plurality of crystalline regions having respective crystal orientations are each rotated around the <211> axis which is the incidence direction to be oriented in the columnar protrusion 114b.

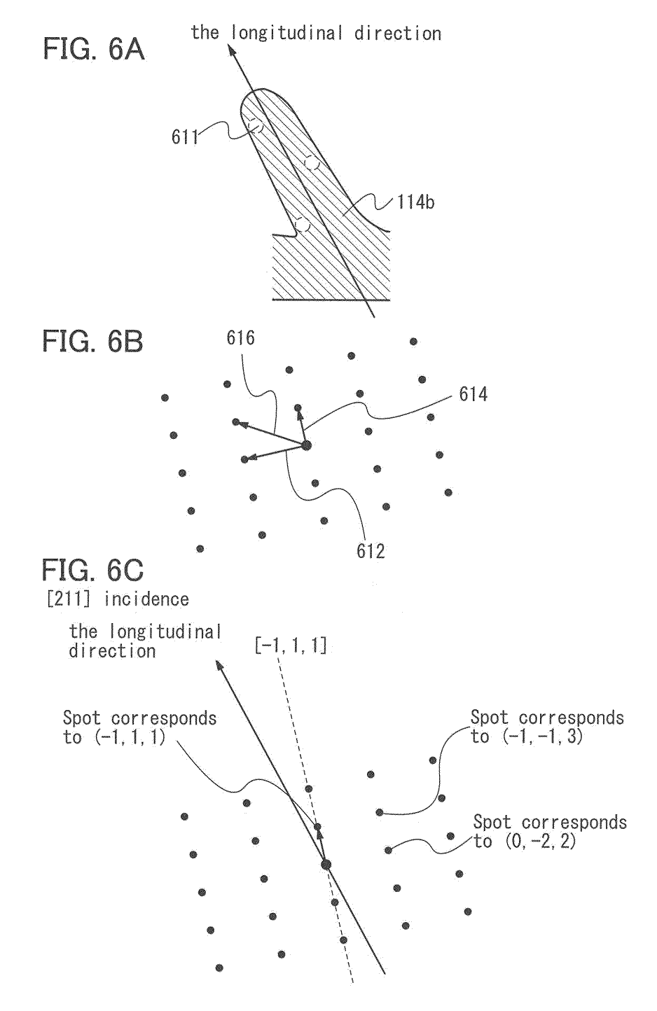

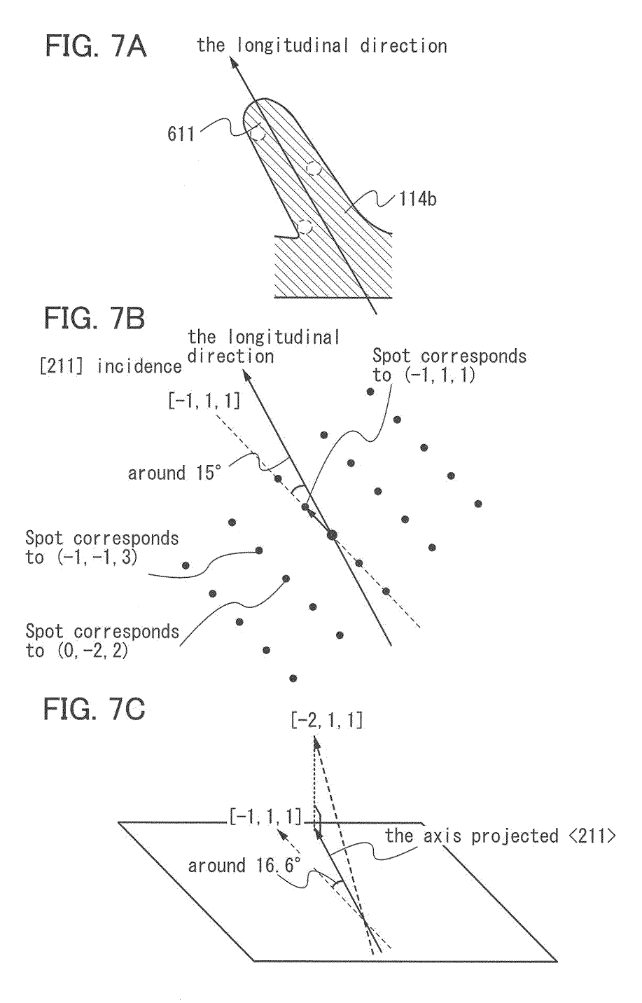

FIG. 6A and FIG. 7A are enlarged views of the columnar protrusion 114b which is surrounded by a dashed line 117 in FIG. 1C. First, a crystalline region 611 which is one of the plurality of crystalline regions having respective crystal orientations will be described. Note that the crystalline region 611 is an example, and a theory similar to that described below is applied to other crystalline regions included in the columnar protrusion 114b as well as the crystalline region 611.

An arrow in FIG. 6A corresponds to the longitudinal direction of the columnar protrusion 114b which is a whisker-like crystal body.

FIG. 6B is an electron diffraction pattern in a longitudinal cross section of the crystalline region 611 having one crystal orientation. This diffraction pattern is obtained by a selected area diffraction method similar to the one described above.

In the diffraction pattern in FIG. 6B, the vectors from the transmission electron spot to three diffraction spots which are not on one straight line passing through the transmission electron spot are represented by an arrow 612, an arrow 614, and an arrow 616. Furthermore, the distances between the transmission electron spot and the three diffraction spots are represented by L₆₁₂, L₆₁₄, and L₆₁₆. The ratio of the length of the arrow 612 to the length of the arrow 614 (L₆₁₂/L₆₁₄) is about 1.633, the ratio of the arrow 616 to the arrow 614 (L₆₁₆/L₆₁₄) is about 1.915, and the angle formed by the arrow 612 and the arrow 614 is about 90°; therefore, the diffraction pattern in FIG. 6B is a pattern of [211] incidence. The spots in the diffraction pattern can be indexed in consideration of a crystal structure of silicon. As in FIG. 6C, the spots can be indexed to be, for example, (−1,1,1), (−1,−1,3), and (0,−2,2).

In FIG. 6C, the orientation of the arrow represented by the straight line passing through the transmission electron spot and the diffraction spot (−1,1,1) is [−1,1,1].

FIG. 7B shows an electron diffraction pattern obtained in a state where a sample is inclined, that is, in a state where the crystalline region 611 is inclined so as to have an angle different from that obtained in the diffraction pattern in FIGS. 6B and 6C. The electron diffraction pattern in FIG. 7B is obtained by a selected area diffraction method similar to the one described above.

An arrow in FIG. 7A corresponds to the longitudinal direction of the columnar protrusion 114b which is a whisker-like silicon crystal body.

The diffraction pattern in FIG. 7B is the same as the diffraction pattern in FIG. 6B except for the inclination, which shows that the diffraction pattern in FIG. 7B is a pattern of [211] incidence. The spots in the diffraction pattern can be indexed in consideration of the crystal structure of silicon. As in FIG. 6B, the spots can be indexed to be, for example, (−1,1,1), (−1,−1,3), and (0,−2,2).

In FIG. 7B, the orientation represented by the arrow on the straight line passing through the transmission electron spot and the diffraction spot (−1,1,1) is [−1,1,1].

In each of FIG. 6B and FIG. 7B, the angle formed by the orientation [−1,1,1] observed from the electron diffraction pattern and the longitudinal direction of the columnar protrusion 114b, which is shown by a solid line, is about 15°.

Here, in a silicon crystal body having the diamond structure, <211> orientations are not orthogonal; thus, diffraction spots indicating the <211> orientation is not observed in the diffraction patterns of the [211] incidence in FIG. 6C and FIG. 7B. In other words, the <211> orientation which is regarded as a rotation axis from FIGS. 5A and 5B does not exist on the (211) plane which provides the diffraction pattern of the [211] incidence; therefore, it is difficult to specify the direction of the rotation axis in this state.

Thus, in order to specify the direction of <211> on the diffraction pattern of the incidence in FIG. 6C and FIG. 7B, the <211> axis is projected onto the (211) plane. This makes it possible to specify the direction on the diffraction pattern of the [211] incidence even though the direction does not exist on the (211) plane and cannot be observed on the diffraction pattern of the [211] incidence. FIG. 7C shows the angle formed by [−1,1,1] shown in FIG. 7B and the <211> axis (here, particularly [−2,1,1]) which is regarded as a rotation axis from FIGS. 5A and 5B at the time when the <211> axis is projected onto the (211) plane.

In FIG. 7C, the angle formed by the orientations [−1,1,1] and [−2,1,1] is about 19.47°. In addition, the direction specified by projecting the orientation [−2,1,1] onto the (211) plane forms an angle of about 16.6° with [−1,1,1] on the (211) plane.

Therefore, it can be said that the direction specified by projecting [−2,1,1] onto the (211) plane, which is shown in FIG. 7C, is substantially the same as the longitudinal direction of the columnar protrusion 114b in FIG. 7B.

Therefore, it can be said that the longitudinal direction of the columnar protrusion 114b which is a whisker-like silicon crystal body is substantially the same as the direction specified by projecting <211> which is regarded as a rotation axis from FIGS. 5A and 5B. In other words, it can be said that the longitudinal direction of the columnar protrusion 114b which is a whisker-like silicon crystal body is substantially the same as <211> which is the preferred orientation of the plurality of crystalline regions included in the columnar protrusion 114b.

As described above, in a polycrystal having the diamond structure, crystal orientations can be regarded as being substantially the same as long as the angle formed by the crystal orientations is approximately less than 20°. In other words, “orientations such as the extension directions of the whisker-like silicon crystal bodies, without limitation to crystal orientations, are substantially the same” means that the angle formed by the orientations is in the range of greater than or equal to 0° and less than 20°, preferably greater than or equal to 0° and less than or equal to 15°, more preferably greater than or equal to 0° and less than or equal to 10°.

Next, an effect produced when the whisker-like silicon crystalline region 103b includes columnar protrusions or needle-like protrusions will be described below.

The columnar protrusions allow increase in the strength of the active material layer in the thickness direction of the whisker-like silicon crystalline region 103b, whereby the electrode can be prevented from being broken. Thus, degradation of an electrode due to vibration or the like can be reduced. Thus, the power storage device can be used for a long time.

Moreover, the needle-like protrusions allow the protrusions to tangle with each other; thus, they can be prevented from being detached when the power storage device is charged or discharged. Consequently, degradation of the electrode due to repetitive charge and discharge can be reduced and the power storage device can be used for a long time.

Furthermore, the needle-like protrusion has a larger surface area per unit mass than the columnar protrusion. The large surface area allows the rate at which a reaction substance (e.g., lithium ions) in a power storage device is absorbed to or released from silicon crystal body to be increased per unit mass. When the rate at which the reaction substance is absorbed or released is increased, the amount of absorption and release of the reaction substance at a high current density is increased; thus, the discharge capacity and charge capacity of the power storage device can be increased. Thus, when a silicon crystal body layer including a whisker-like silicon crystalline region as an active material layer so that needle-like protrusions are included in the silicon crystalline region, the performance of the power storage device can be improved.

### (Manufacturing Method of Electrode of Power Storage Device)

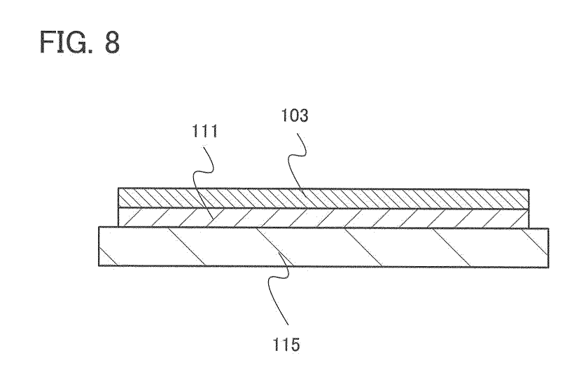

Next, an example of a manufacturing method of an electrode of a power storage device will be described with reference to FIGS. 1A to 1C and FIG. 8.

As illustrated in FIG. 1A, a silicon crystalline layer is formed as an active material layer 103 over a current collector 101 by a thermal CVD method, preferably an LPCVD method.

In FIGS. 1A to 1C, a conductive material having a foil shape, a plate shape, or a net shape is used as the current collector 101. The current collector 101 may be formed using, without particular limitation, a metal element with high conductivity, typified by platinum, aluminum, copper, or titanium. Note that the current collector 101 may be formed using an aluminum alloy to which an element which improves heat resistance, such as silicon, titanium, neodymium, scandium, or molybdenum, is added.

Alternatively, the current collector 101 may be formed using a metal element which forms silicide by reacting with silicon. Examples of the metal element which forms silicide by reacting with silicon include zirconium, titanium, hafnium, vanadium, niobium, tantalum, chromium, molybdenum, tungsten, cobalt, nickel, and the like.

Note that oxygen is contained as an impurity in current collector 101 in some cases. This is because oxygen is desorbed from a quartz reaction chamber of an LPCVD apparatus by heating performed in the formation of the silicon crystalline layer as the active material layer 103 by an LPCVD method, and the oxygen diffuses into the current collector 101.

Alternatively, as illustrated in FIG. 8, the current collector 111 can be formed over a substrate 115 by a sputtering method, an evaporation method, a printing method, an ink-jet method, a CVD method, or the like as appropriate. A glass substrate, a semiconductor substrate containing a semiconductor material such as silicon, or the like can be used as the substrate 115.

Then, as illustrated in FIG. 1A, a silicon crystalline layer is formed on the current collector 101 as the active material layer 103 by a thermal CVD method, preferably by an LPCVD method. Note that although the example in which the active material layer 103 is formed on one surface of the current collector 101 is illustrated in FIG. 1A, the active material layer 103 may be formed on both surfaces of the current collector.

In the LPCVD method, a deposition gas containing silicon is used as a source gas while heating is performed at temperatures higher than 550° C. and lower than or equal to the temperature that the LPCVD apparatus and the current collector 101 can withstand, preferably higher than or equal to 580° C. and lower than 650° C. Examples of the deposition gas containing silicon include silicon hydride, silicon fluoride, and silicon chloride; typically, SiH₄, Si₂H₆, SiF₄, SiCl₄, Si₂Cl₆, and the like are given. Note that one or more of rare gases such as helium, neon, argon, and xenon and hydrogen may be mixed in the source gas.

Note that an impurity element imparting one conductivity type, such as phosphorus or boron, may be added to the silicon crystalline layer. The silicon layer to which the impurity element imparting one conductivity type, such as phosphorus or boron, is added has higher conductivity, so that the conductivity of the negative electrode can be increased. Accordingly, the discharge capacity can be even larger.

When the silicon crystalline layer is formed as the active material layer 103 by the LPCVD method, a low-density region is not formed between the current collector 101 and the active material layer 103, ions and electrons transfer easily at the interface between the current collector 101 and the silicon crystalline layer, and the adhesion can be increased. This can be explained by the following reason: active species of the source gas are constantly supplied to the silicon crystalline layer that is being deposited in a step of forming the silicon crystalline layer, so that silicon diffuses into the current collector 101 from the silicon crystalline layer; even if a region lacking silicon (a sparse region) is formed, the active species of the source gas are constantly supplied to the region, so that a low-density region is unlikely to be formed in the current collector 101. In addition, since the silicon crystalline layer is formed over the current collector 101 by vapor deposition, throughput can be improved.

As illustrated in FIGS. 1B and 1C, a mixed layer 107 may be formed over the current collector 101. For example, the mixed layer 107 may be formed using silicon and a metal element included in the current collector 101. In the case where the mixed layer 107 is formed using silicon and the metal element included in the current collector 101, the mixed layer 107 can be formed by diffusion of silicon from the silicon crystalline layer into the current collector 101 which is caused by the heating for forming the silicon crystalline layer as the active material layer 103 by an LPCVD method.

In the case where the current collector 101 is formed using a metal element which forms silicide by reacting with silicon, silicide including silicon and the metal element which forms silicide is formed in the mixed layer 107; typically, one or more of zirconium silicide, titanium silicide, hafnium silicide, vanadium silicide, niobium silicide, tantalum silicide, chromium silicide, molybdenum silicide, tungsten silicide, cobalt silicide, and nickel silicide, is/are formed. Alternatively, an alloy layer of silicon and the metal element which forms silicide is formed.

When the mixed layer 107 is provided between the current collector 101 and the active material layer 103, the resistance at the interface between the current collector 101 and the active material layer 103 can be reduced; thus, the electric conductivity of the negative electrode can be increased. Accordingly, the discharge capacity can be even higher. In addition, the adhesion between the current collector 101 and the active material layer 103 can be increased, so that degradation of the power storage device can be suppressed.

Over the mixed layer 107, a metal oxide layer 109 which is formed using an oxide of the metal element included in the current collector 101 may be formed. This is because oxygen is released from the quartz reaction chamber of the LPCVD apparatus in the heating for forming the silicon crystalline layer as the active material layer 103 by the LPCVD method and the current collector 101 is oxidized. Note that by filling the reaction chamber with a rare gas such as helium, neon, argon, or xenon, in forming the silicon crystalline layer by the LPCVD method, the metal oxide layer 109 is not formed.

In the case where the current collector 101 is formed using the metal element which forms silicide by reacting with silicon, a metal oxide layer containing an oxide of the metal element which forms silicide by reacting with silicon is formed as the metal oxide layer 109.

The metal oxide layer 109 is formed using, typically, zirconium oxide, titanium oxide, hafnium oxide, vanadium oxide, niobium oxide, tantalum oxide, chromium oxide, molybdenum oxide, tungsten oxide, cobalt oxide, nickel oxide, or the like. Note that when the current collector 101 is formed using titanium, zirconium, niobium, tungsten, or the like, the metal oxide layer 109 is formed of an oxide semiconductor such as titanium oxide, zirconium oxide, niobium oxide, or tungsten oxide; thus, the resistance between the current collector 101 and the active material layer 103 can be reduced and the electrical conductivity of the electrode can be increased. Accordingly, the discharge capacity can be even higher.

Through the above steps, a negative electrode active material capable of increasing discharge capacity can be manufactured and a high-performance power storage device including the negative electrode active material can be manufactured.

This embodiment can be implemented in appropriate combination with any of the structures described in the other embodiments.

### Embodiment 2

The silicon crystal body described in Embodiment 1 can be used for an electrode of a power storage device. A secondary battery or a capacitor can be formed using at least a pair of electrodes, an electrolyte, and a separator.

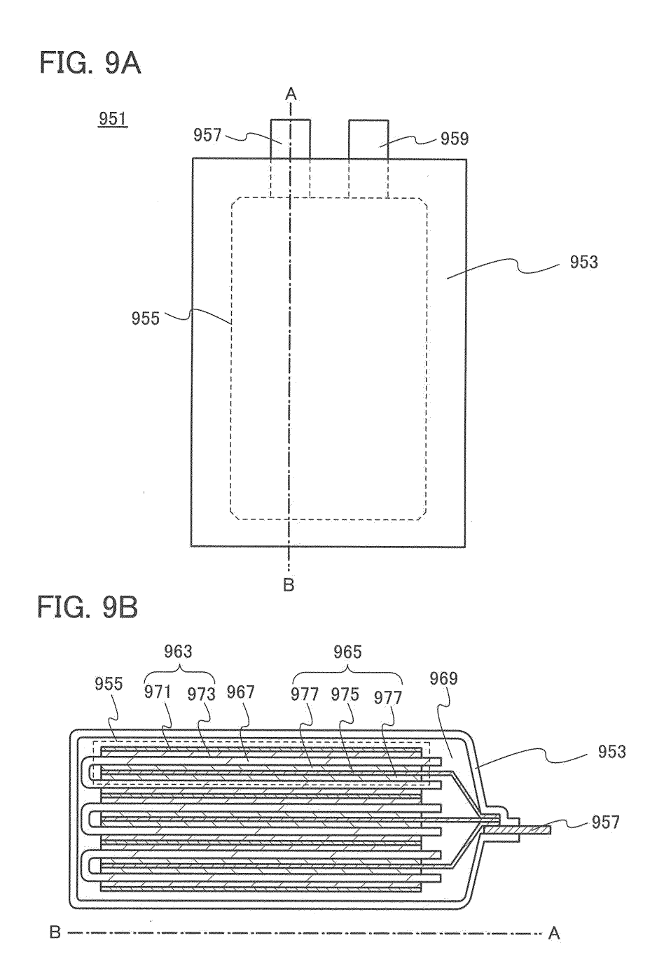

In this embodiment, as an example of the power storage device, a lithium ion secondary battery in which one electrode is formed using the silicon crystal body described in Embodiment 1 and the other electrode is formed using a lithium-containing metal oxide such as LiCoO₂, and a manufacturing method of the lithium ion secondary battery will be described with reference to FIGS. 9A and 9B.

FIG. 9A is a plan view of a power storage device 951, and FIG. 9B is a cross-sectional view taken along dot-dashed line A-B in FIG. 9A.

The power storage device 951 illustrated in FIG. 9A includes an power storage cell 955 in an exterior member 953. Terminal portions 957 and 959 which are connected to the power storage cell 955 are also provided. As the exterior member 953, a laminate film, a polymer film, a metal film, a metal case, a plastic case, or the like can be used.

As illustrated in FIG. 9B, the power storage cell 955 includes a negative electrode 963, a positive electrode 965, a separator 967 provided between the negative electrode 963 and the positive electrode 965, and an electrolyte 969 with which the exterior member 953 is filled.

The negative electrode 963 includes a negative electrode current collector 971 and a negative electrode active material layer 973. The electrode in Embodiment 1 can be used as the negative electrode 963.

As the negative electrode active material layer 973, the active material layer 103 formed using the silicon crystalline layer described in Embodiment 1 can be used. The silicon crystalline layer may be pre-doped with lithium. In addition, the negative electrode active material layer 973 which is formed using the crystalline silicon layer is formed while the negative electrode current collector 971 is held by a frame-like susceptor, whereby the negative electrode active material layers 973 can be formed on both surfaces of the negative electrode current collector 971 at the same time; thus, the number of steps can be reduced in the case where an electrode is formed using both surfaces of the negative electrode current collector 971 in an LPCVD apparatus.

The positive electrode 965 includes a positive electrode current collector 975 and a positive electrode active material layer 977. The negative electrode active material layer 973 is formed on one or both of the surfaces of the negative electrode current collector 971. The positive electrode active material layer 977 is formed on one or both of the surfaces of the positive electrode current collector 975.

The negative electrode current collector 971 is connected to the terminal portion 957. The positive electrode collector 975 is connected to the terminal portion 957. Further, parts of the terminal portions 957 and 959 extend out from the exterior member 953.

Note that although a sealed thin power storage device is described as the power storage device 951 in this embodiment, a storage device can have a variety of structures; for example, a button power storage device, a cylindrical power storage device, or a rectangular power storage device can be used. Further, although the structure where the positive electrode, the negative electrode, and the separator are stacked is described in this embodiment, a structure where the positive electrode, the negative electrode, and the separator are rolled may be employed.

Aluminum, stainless steel, or the like is used for the positive electrode collector 975. The positive electrode current collector 975 can have a foil shape, a plate shape, a net shape, a film shape, or the like as appropriate.

The positive electrode active material layer 977 can be formed using LiFeO₂, LiCoO₂, LiNiO₂, LiMn₂O₄, LiFePO₄, LiCoPO₄, LiNiPO₄, LiMn₂PO₄, V₂O₅, Cr₂O₅, MnO₂, or other lithium compounds as a material. Note that in the case where carrier ions are alkali metal ions other than lithium ions; beryllium ions; magnesium ions; or alkaline earth metal ions, the positive electrode active material layer 977 can be formed using, instead of lithium in the above lithium compounds, an alkali metal (e.g., sodium or potassium), beryllium, magnesium, or an alkaline earth metal (e.g., calcium, strontium, or barium).

As a solute of the electrolyte 969, a material in which lithium ions, which are carrier ions, can move and stably exist is used. Typical examples of the solute of the electrolyte include lithium salt such as LiClO₄, LiAsF₆, LiBF₄, LiPF₆, and Li(C₂F₅SO₂)₂N. Note that in the case where carrier ions are alkali metal ions other than lithium ions; beryllium ions; magnesium ions; or alkaline earth metal ions, the solute of the electrolyte 969 can be formed using alkali metal salt (e.g., sodium salt or potassium salt); beryllium salt; magnesium salt; an alkaline earth metal salt (e.g., calcium salt, strontium salt, or barium salt), or the like as appropriate.

As a solvent of the electrolyte 969, a material which can transfer lithium ions is used. As the solvent of the electrolyte 969, an aprotic organic solvent is preferably used. Typical examples of aprotic organic solvents include ethylene carbonate, propylene carbonate, dimethyl carbonate, diethyl carbonate, γ-butyrolactone, acetonitrile, dimethoxyethane, tetrahydrofuran, and the like, and one or more of these materials can be used. When a gelled polymer material is used as the solvent of the electrolyte 969, safety of the power storage device 951 against liquid leakage or the like can be increased. In addition, the power storage device 951 can be thin and lightweight. Typical examples of gelled polymers include a silicon gel, an acrylic gel, an acrylonitrile gel, polyethylene oxide, polypropylene oxide, a fluorine-based polymer, and the like.

As the electrolyte 969, a solid electrolyte such as Li₃PO₄ can be used.

For the separator 967, an insulating porous material is used. Typical examples of the separator 967 include cellulose (paper), polyethylene, and polypropylene.

A lithium ion battery has a small memory effect, a high energy density, and a large discharge capacity. In addition, the driving voltage of the lithium ion battery is high. For those reasons, the size and weight of the lithium ion battery can be reduced. Further, the lithium ion battery is not easily degraded due to repetitive charge and discharge and can be used for a long time, and therefore allows cost reduction.

Next, a capacitor will be described as a power storage device. Typical examples of the capacitor include an electrical double-layer capacitor, a lithium ion capacitor, and the like.

In the case of a capacitor, instead of the positive electrode active material layer 977 in the secondary battery in FIG. 9B, a material capable of reversibly absorbing and releasing one of both of lithium ions and anions may be used. Typical examples of the positive electrode active material layer 977 include active carbon, a conductive polymer, and a polyacene organic semiconductor (PAS).

The lithium ion capacitor has high efficiency of charge and discharge, capability of rapidly performing charge and discharge, and a long life even when it is repeatedly used.

By using the negative electrode described in Embodiment 1 as the negative electrode 963, a power storage device with a high discharge capacity and less degradation of an electrode due to repetitive charge and discharge can be manufactured.

Further, when the current collector and the active material layer that are described in Embodiment 1 are used in a negative electrode of an air cell that is another embodiment of a power storage device, a power storage device with a high discharge capacity and less degradation of an electrode due to repetitive charge and discharge can be manufactured.

This embodiment can be implemented in appropriate combination with any of the structures described in the other embodiments.

### Embodiment 3

The silicon crystal body having such an advantageous shape, which is described in Embodiment 1, can also be used for, for example, an electron gun, micro electro mechanical systems (MEMS), and a probe in a measuring instrument.

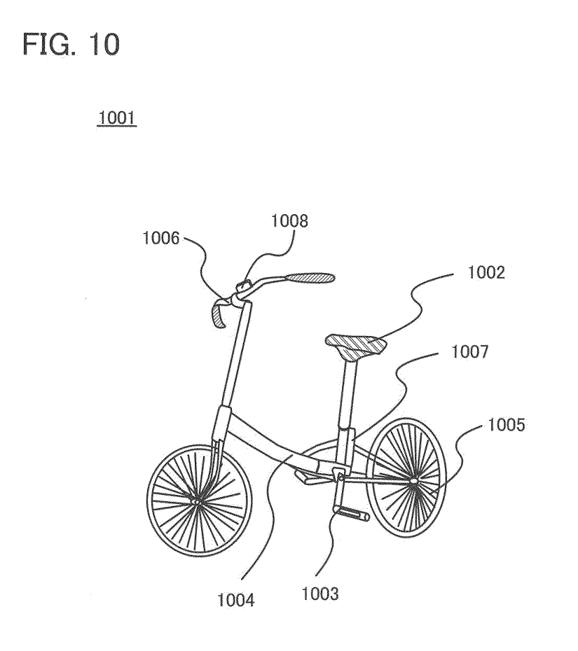

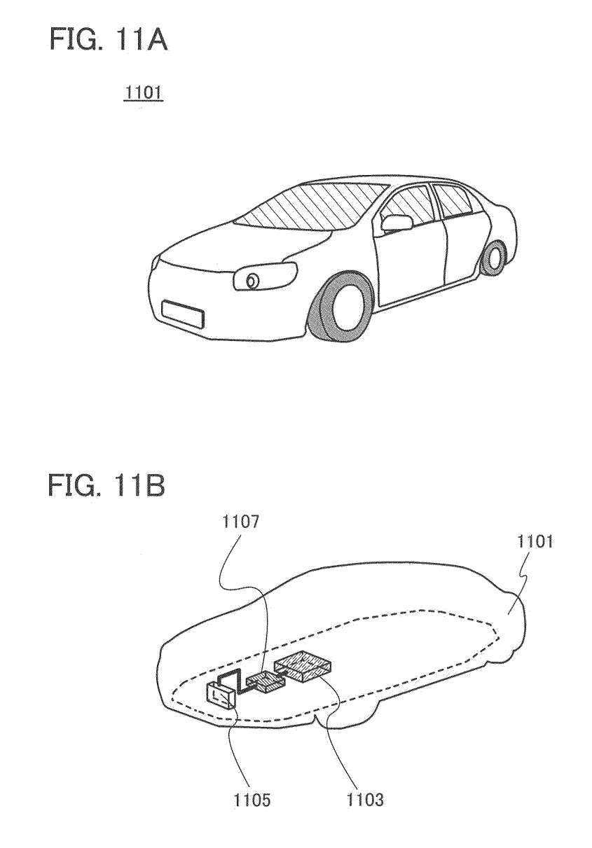

Moreover, in this embodiment, an application example of the power storage device described in Embodiment 2 will be described with reference to FIG. 10 and FIGS. 11A and 11B.

The power storage device described in Embodiment 2 can be used in electronic devices, such as cameras such as digital cameras or video cameras, digital photo frames, mobile phones (also referred to as cellular phones or cellular phone devices), portable game machines, portable information terminals, or audio reproducing devices. Further, the power storage device can be used in electric propulsion vehicles such as electric vehicles, hybrid electric vehicles, train vehicles, maintenance vehicles, carts, or wheelchairs. Here, as a typical example of the electric propulsion vehicles, an electric bicycle and a wheelchair will be described.

FIG. 10 is a perspective view of an electric bicycle (or a power-assisted bicycle). The electric bicycle 1001 includes a saddle 1002 on which the rider sits, pedals 1003, a frame 1004, wheels 1005, handlebars 1006 for steering wheels 1005, a driver portion 1007 attached to the frame 1004, and a display device 1008 provided near the handlebars 1006.

The driver portion 1007 includes a motor, a battery, a controller, and the like. The controller detects conditions of the battery (e.g., current, voltage, or a temperature of the battery). The controller adjusts the discharge amount of the battery to control the motor when the electric bicycle 1001 moves, while the controller controls the charge amount when the battery is charged. Further, the driver portion 1007 may be provided with a sensor which senses the pressure that the rider puts on the pedals 1003, the driving speed, and the like and the motor may be controlled according to information from the sensor. Note that while FIG. 10 illustrates a structure where the driver portion 1007 is mounted on the frame 1004, the mounting position of the driver portion 1007 is not limited thereto.

The display device 1008 includes a display portion, a switching button, and the like. The display portion displays the remaining capacity in the battery, the driving speed, and the like. In addition, with the switching button, the motor can be controlled or the display content on the display portion can be changed. Note that while FIG. 10 illustrates a structure where the display device 1008 is mounted near the handlebars 1006, the mounting position of the display device 1008 is not limited thereto.

The power storage device described in Embodiment 2 can be used for the battery of the driver portion 1007. The battery of the driver portion 1007 can be externally charged by electric power supply using a plug-in system or contactless power feeding. Further, the power storage device described in Embodiment 2 can be used for the display device 1008.

FIG. 11A is a perspective view of an electric vehicle 1101. FIG. 11B is a transparent view of the electric vehicle 1101 illustrated in FIG. 11A. The electric vehicle 1101 obtains power when current flows through a motor 1103. The electric vehicle 1101 includes a battery 1105 and a power control portion 1107 for supplying current flowing though the motor 1103. Although a means to charge the battery 1105 is not particularly illustrated in FIG. 11B, the battery 1105 may be charged by an electric generator or the like that is additionally provided.

The power storage device described in Embodiment 2 can be used in the battery 1105. The battery 1105 can be externally charged by electric power supply using plug-in systems or contactless power feeding. Note that in the case where the electric propulsion vehicle is a train vehicle, the battery can be charged by electric power supply from an overhead cable or a conductor rail.

### Embodiment 4

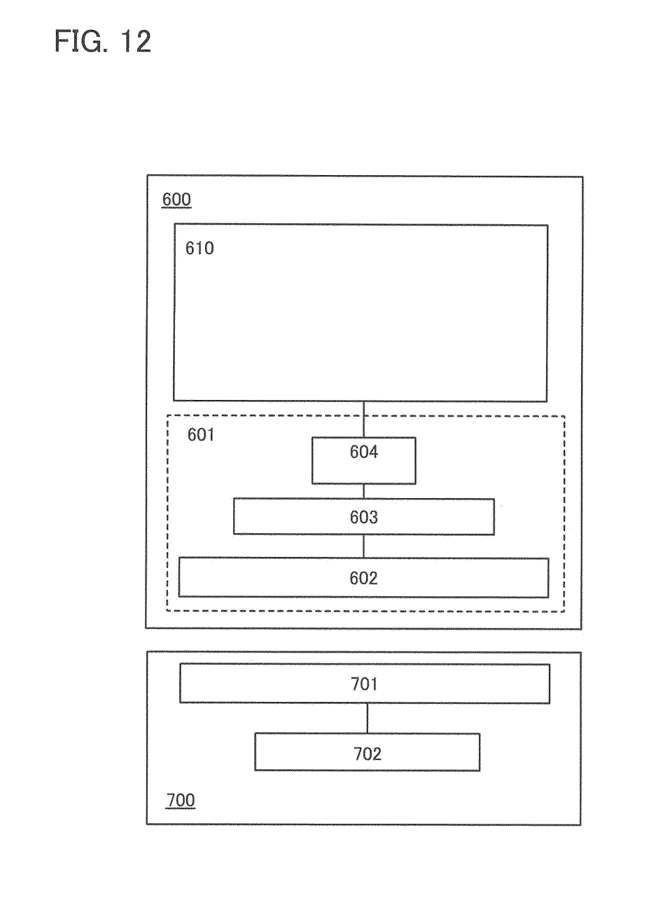

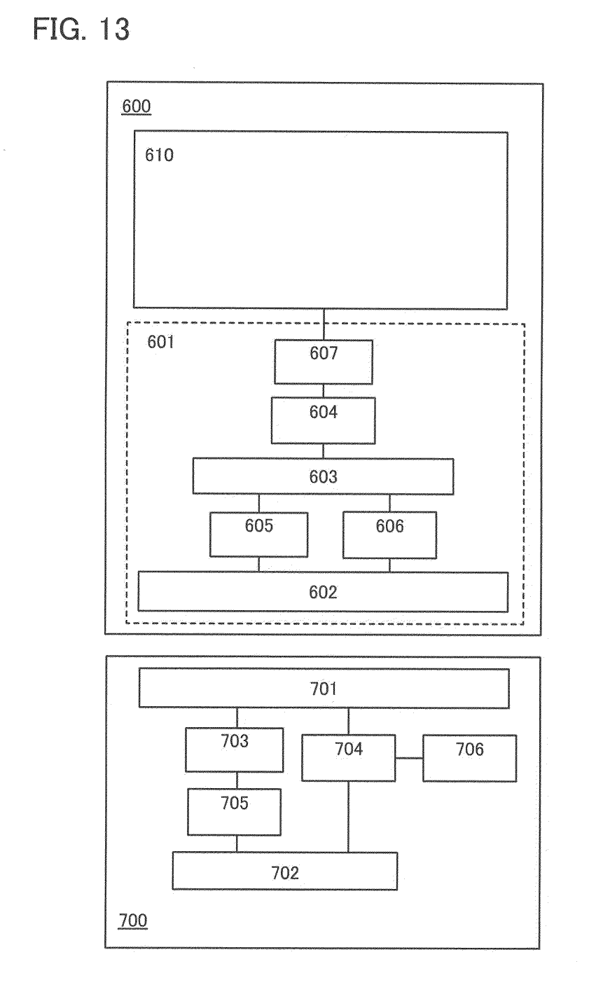

In this embodiment, an example in which a secondary battery that is an example of the power storage device according to one embodiment of the present invention is used in a wireless power feeding system (hereinafter referred to as an RF power feeding system) will be described with reference to block diagrams of FIG. 12 and FIG. 13. In each of the block diagrams, independent blocks show elements within a power receiving device and a power feeding device, which are classified according to their functions. However, it may be practically difficult to completely separate the elements according to their functions; in some cases, one element can involve a plurality of functions.

First, the RF power feeding system is described with reference to FIG. 12.

A power receiving device 600 is an electronic device or an electric propulsion vehicle which is driven by electric power supplied from a power feeding device 700, and can be applied to another device which is driven by electric power, as appropriate. Typical examples of the electronic device include cameras such as digital cameras or video cameras, digital photo frames, mobile phones (also referred to as cellular phones or cellular phone devices), portable game machines, portable information terminals, audio reproducing devices, display devices, computers, and the like. Typical examples of the electric propulsion vehicles include electric vehicles, hybrid electric vehicles, train vehicles, maintenance vehicles, carts, wheelchairs, and the like. In addition, the power feeding device 700 has a function of supplying electric power to the power receiving device 600.

In FIG. 12, the power receiving device 600 includes the power receiving device portion 601 and the power load portion 610. The power receiving device portion 601 includes at least a power receiving device antenna circuit 602, a signal processing circuit 603, and a secondary battery 604. The power feeding device 700 includes at least a power feeding device antenna circuit 701 and a signal processing circuit 702.

The power receiving device antenna circuit 602 has a function of receiving a signal transmitted by the power feeding device antenna circuit 701 or transmitting a signal to the power feeding device antenna circuit 701. The signal processing circuit 603 processes a signal received by the power receiving device antenna circuit 602 and controls charging of the secondary battery 604 and supplying of electric power from the secondary battery 604 to the power load portion 610. In addition, the signal processing circuit 603 controls operation of the power receiving device antenna circuit 602. In other words, the signal processing circuit 603 can control the intensity, the frequency, or the like of a signal transmitted by the power receiving device antenna circuit 602. The power load portion 610 is a driving portion which receives electric power from the secondary battery 604 and drives the power receiving device 600. Typical examples of the power load portion 610 include a motor, a driving circuit, and the like. Another device which drives the power receiving device by receiving electric power can be used as the power load portion 610 as appropriate. The power feeding device antenna circuit 701 has a function of transmitting a signal to the power receiving device antenna circuit 602 or receiving a signal from the power receiving device antenna circuit 602. The signal processing circuit 702 processes a signal received by the power feeding device antenna circuit 701. In addition, the signal processing circuit 702 controls operation of the power feeding device antenna circuit 701. That is, the signal processing circuit 702 can control the intensity, the frequency, or the like of a signal transmitted by the power feeding device antenna circuit 701.

The secondary battery according to one embodiment of the present invention is used as the secondary battery 604 included in the power receiving device 600 in the RF power feeding system illustrated in FIG. 12.

With the use of the secondary battery according to one embodiment of the present invention in the RF power feeding system, the amount of power storage can be made larger than that in a conventional secondary battery. Accordingly, the time interval of the wireless power feeding can be longer (frequent power feeding can be omitted).

In addition, with the use of the secondary battery according to one embodiment of the present invention in the RF power feeding system, the power receiving device 600 can be formed to be compact and lightweight if the amount of power storage with which the power load portion 610 can be driven is the same as that in a conventional secondary battery. Therefore, the total cost can be reduced.

Next, another example of the RF power feeding system will be described with reference to FIG. 13.

In FIG. 13, the power receiving device 600 includes a power receiving device portion 601 and a power load portion 610. The power receiving device portion 601 includes at least the power receiving device antenna circuit 602, the signal processing circuit 603, the secondary battery 604, a rectifier circuit 605, a modulation circuit 606, and a power supply circuit 607. In addition, the power feeding device 700 includes at least the power feeding device antenna circuit 701, the signal processing circuit 702, a rectifier circuit 703, a modulation circuit 704, a demodulation circuit 705, and an oscillator circuit 706.

The power receiving device antenna circuit 602 has a function of receiving a signal transmitted by the power feeding device antenna circuit 701 or transmitting a signal to the power feeding device antenna circuit 701. In the case where the power receiving device antenna circuit 602 receives a signal transmitted by the power feeding device antenna circuit 701, the rectifier circuit 605 has a function of generating DC voltage from the signal received by the power receiving device antenna circuit 602. The signal processing circuit 603 has a function of processing a signal received by the power receiving device antenna circuit 602 and controlling charging of the secondary battery 604 and supplying of electric power from the secondary battery 604 to the power supply circuit 607. The power supply circuit 607 has a function of converting voltage stored in the secondary battery 604 into voltage needed for the power load portion 610. The modulation circuit 606 is used when a certain response is transmitted from the power receiving device 600 to the power feeding device 700.

With the power supply circuit 607, electric power supplied to the power load portion 610 can be controlled. Thus, overvoltage application to the power load portion 610 can be suppressed, and deterioration or breakdown of the power receiving device 600 can be reduced.

In addition, with the modulation circuit 606, a signal can be transmitted from the power receiving device 600 to the power feeding device 700. Thus, in the case where the amount of charged power in the power receiving device 600 is judged and a certain amount of power is charged, a signal is transmitted from the power receiving device 600 to the power feeding device 700 so that power feeding from the power feeding device 700 to the power receiving device 600 can be stopped. As a result, the secondary battery 604 is not fully charged, which increases the number of times the secondary battery 604 can be charged.

The power feeding device antenna circuit 701 has a function of transmitting a signal to the power receiving device antenna circuit 602 or receiving a signal from the power receiving device antenna circuit 602. When a signal is transmitted to the power receiving device antenna circuit 602, the signal processing circuit 702 generates a signal which is transmitted to the power receiving device 600. The oscillator circuit 706 is a circuit which generates a signal with a constant frequency. The modulation circuit 704 has a function of applying voltage to the power feeding device antenna circuit 701 in accordance with the signal generated by the signal processing circuit 702 and the signal with a constant frequency generated by the oscillator circuit 706. Thus, a signal is output from the power feeding device antenna circuit 701. On the other hand, when a signal is received from the power receiving device antenna circuit 602, the rectifier circuit 703 rectifies the received signal. From signals rectified by the rectifier circuit 703, the demodulation circuit 705 extracts a signal transmitted from the power receiving device 600 to the power feeding device 700. The signal processing circuit 702 has a function of analyzing the signal extracted by the demodulation circuit 705.

Note that any of a variety of circuits may be provided between the circuits as long as the RF power feeding can be performed. For example, after the power receiving device 600 receives a signal and the rectifier circuit 605 generates DC voltage, a circuit such as a DC-DC converter or regulator that is provided in a subsequent stage may generate constant voltage. Thus, overvoltage application to the inside of the power receiving device 600 can be suppressed.

A secondary battery according to one embodiment of the present invention is used as the secondary battery 604 included in the power receiving device 600 in the RF power feeding system in FIG. 13.

With the use of the secondary battery according to one embodiment of the present invention in the RF power feeding system, the amount of power storage can be larger than that in a conventional secondary battery. Accordingly, the time interval of the wireless power feeding can be longer (frequent power feeding can be omitted).

In addition, with the use of the secondary battery according to one embodiment of the present invention in the RF power feeding system, the power receiving device 600 can be formed to be compact and lightweight if the amount of power storage with which the power load portion 610 can be driven is the same as that in a conventional secondary battery. Therefore, the total cost can be reduced.

Note that when the secondary battery according to one embodiment of the present invention is used in the RF power feeding system and the power receiving device antenna circuit 602 and the secondary battery 604 are overlapped with each other, it is preferable that the impedance of the power receiving device antenna circuit 602 is not changed by deformation of the secondary battery 604 due to charge and discharge of the secondary battery 604 and accompanying deformation of the antenna. When the impedance of the antenna is changed, in some cases, electric power is not supplied sufficiently. For example, the secondary battery 604 may be contained in a battery pack formed using metal or ceramics. Note that in that case, the power receiving device antenna circuit 602 and the battery pack are preferably separated from each other by several tens of micrometers or more.

In this embodiment, the charging signal has no limitation on its frequency and may have any band of frequency as long as electric power can be transmitted. For example, the charging signal may have any of an LF band of 135 kHz (long wave), an HF band of 13.56 MHz, a UHF band of 900 MHz to 1 GHz, and a microwave band of 2.45 GHz.

A signal transmission method may be properly selected from various methods including an electromagnetic coupling method, an electromagnetic induction method, a resonance method, and a microwave method. In order to prevent energy loss due to foreign substances containing moisture, such as rain and mud, the electromagnetic induction method or the resonance method using a low frequency band, specifically, very-low frequencies of 3 kHz to 30 kHz, low frequencies of 30 kHz to 300 kHz, medium frequencies of 300 kHz to 3 MHz, or high frequencies of 3 MHz to 30 MHz is preferably used.

This embodiment can be implemented in combination with any of the above embodiments.

### EXAMPLE 1

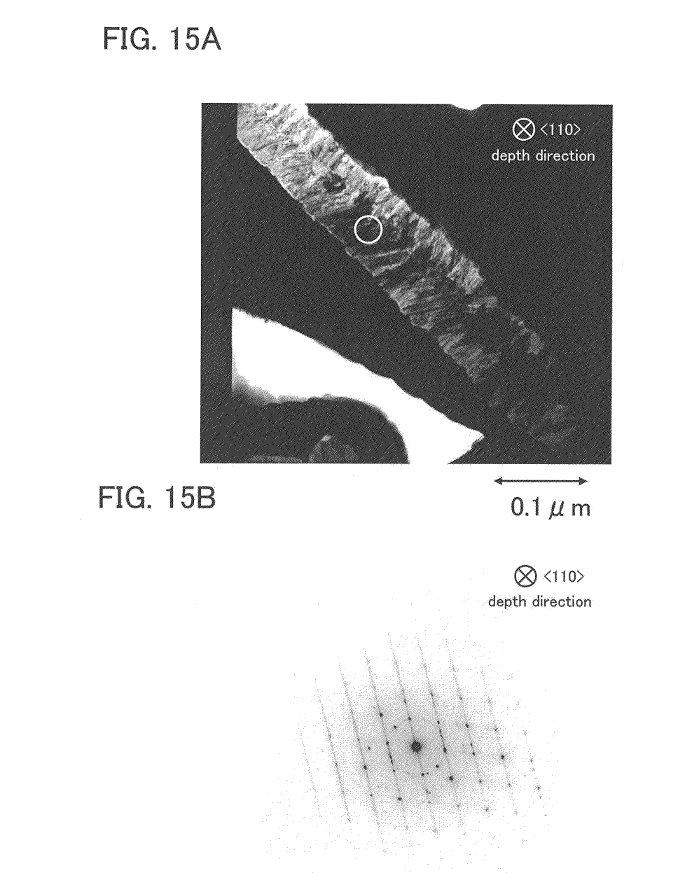

In this example, a silicon crystal body used for forming a pair of electrodes in a power storage device that is one embodiment of the present invention will be described with reference to FIGS. 15A and 15B, FIGS. 16A and 16B, FIGS. 17A and 17B, FIGS. 18A and 18B, FIGS. 19A and 19B, and FIGS. 20A and 20B.

### (Manufacturing Process of Electrode of Lithium Ion Secondary Battery)

First, a manufacturing method of an electrode of a lithium ion secondary battery will be described using the lithium ion secondary battery as an example of the power storage device.

An active material layer was formed over a current collector, so that the electrode of the lithium ion secondary battery was manufactured.

Titanium was used as a material of the current collector. As the current collector, a sheet of a titanium film (also referred to as a titanium sheet) with a thickness of 100 μm was used.

A silicon crystal body that is one embodiment of the present invention was used as the active material layer.

Over the titanium film, which is the current collector, the silicon crystal body was formed by an LPCVD method. Deposition of the silicon crystal body by an LPCVD method was performed as follows: silane was introduced as a source gas with a flow rate of 300 sccm into a reaction chamber, the pressure in the reaction chamber was 20 Pa, and the temperature in the reaction chamber was 600° C. The reaction chamber was made of quartz. When the temperature of the current collector was increased, a small amount of He was introduced.

The silicon crystal body obtained in the above process was used as the active material layer of the lithium ion secondary battery.

### (Structure of Electrode of Lithium Ion Secondary Battery)

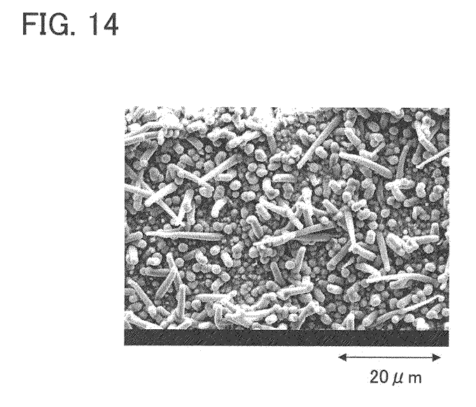

FIG. 14 is a planar scanning electron microscope (SEM) image of the silicon crystal body obtained in the above process. As shown in FIG. 14, it was confirmed that the silicon crystal body obtained in the above process included a plurality of columnar (cylindrical or prismatic) or needle-like (conical or pyramidal) protrusions. Therefore, the surface area of the active material layer can be increased. It was also confirmed that a long protrusion had a length of approximately 15 μm to 20 μm. As well as the long protrusions, a plurality of short protrusions existed among the long protrusions. It was confirmed that the columnar protrusion was not formed perpendicularly to an interface between the titanium film and the silicon crystalline layer but extended diagonally. Thus, the height of the columnar protrusion corresponds to the length of the columnar protrusion, which means that the height of the columnar protrusion does not correspond to the thickness of a silicon crystalline region.

Some columnar protrusions had rounded top portions. Some columnar protrusions had narrower diameters toward the tops. The directions of the axes of the columnar protrusions varied.

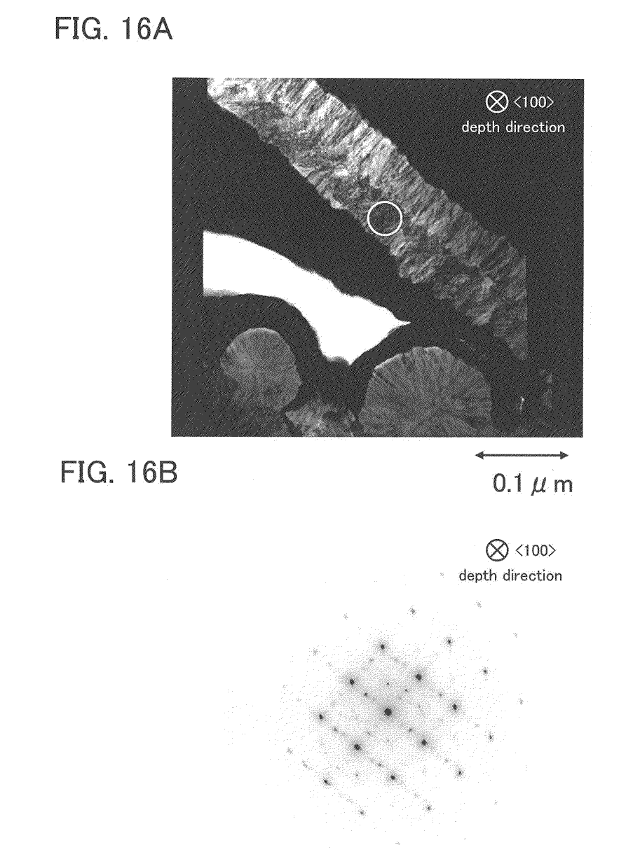

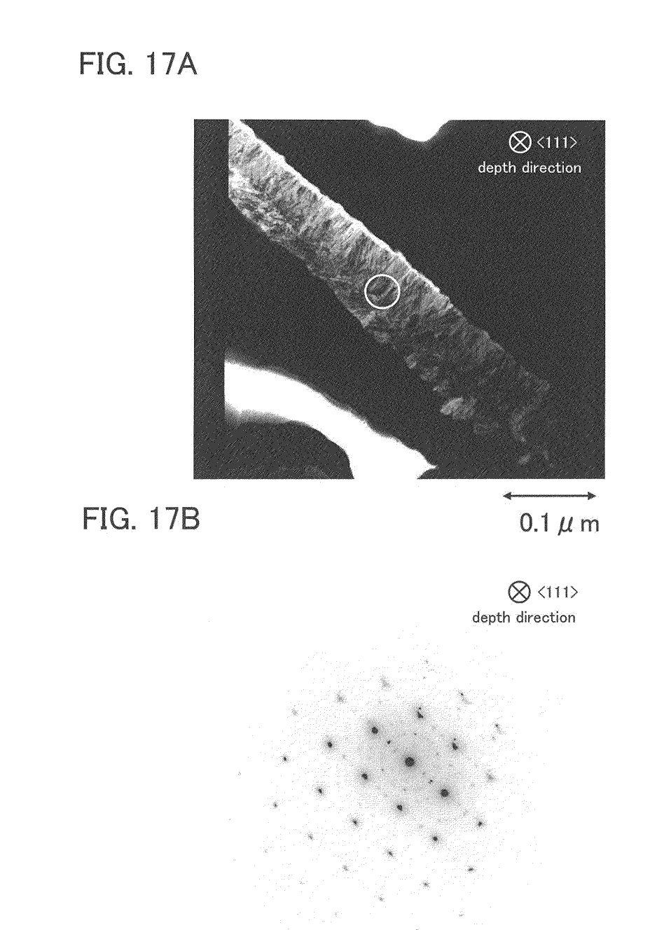

FIG. 15A, FIG. 16A, and FIG. 17A are cross-sectional transmission electron microscope (TEM) images in the longitudinal direction of the silicon crystal body which is the needle-like protrusion obtained in the above steps. FIG. 15A, FIG. 16A, and FIG. 17A are images of the silicon crystal body that was an observation sample and was observed at different inclination angles in the range of −15° to +15°. FIG. 15B, FIG. 16B, and FIG. 17B show electron diffraction patterns corresponding to the positions of white circles in FIG. 15A, FIG. 16A, and FIG. 17A, respectively.

FIG. 15A, FIG. 16A, and FIG. 17A show that the contrast density (hue) in the cross-sectional TEM images of the silicon crystal body is ununiformly changed when the observation at the different inclination angles was performed. In cross-sectional TEM images of single crystal silicon, the contrast density of the whole image is uniformly changed with change in inclination angle. Therefore, the observation confirmed that the silicon crystal body which was the needle-like protrusion was not a single crystal but included a plurality of crystalline regions having substantially the same crystal orientation.

The electron diffraction pattern in FIG. 15B was confirmed to be a diffraction pattern including <110> incidence from the ratio between the distance between the transmission electron spot and a diffraction spot and the distance between the transmission electron spot and another diffraction spot, and the angle formed by the straight lines connecting the transmission electron spot and the diffraction spots. The electron diffraction pattern in FIG. 16B was similarly confirmed to be a diffraction pattern including <100> incidence. The electron diffraction pattern in FIG. 17B was similarly confirmed to be a diffraction pattern including <111> incidence.

Indexation of the diffraction pattern confirmed that <110> direction was a preferred orientation of the plurality of crystalline regions included in the silicon crystal body which was the needle-like protrusion. In addition, extension directions of the silicon crystal body which are shown in FIG. 15B, FIG. 16B, and FIG. 17B were confirmed to be substantially the same as the <110> direction.

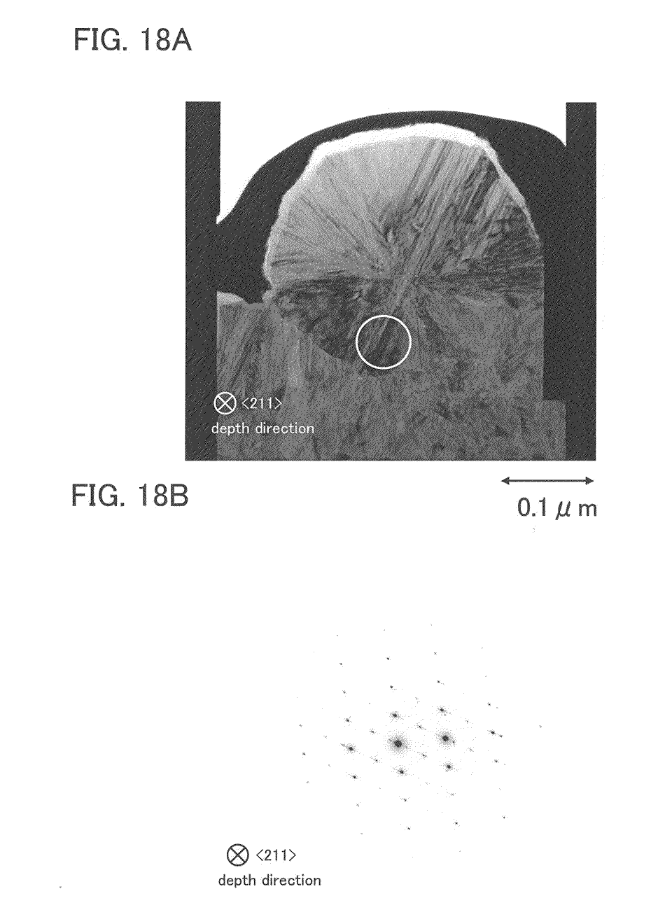

FIG. 18A is a cross-sectional TEM image in a transverse cross section of the silicon crystal body which is the columnar protrusion obtained in the above steps. FIG. 18B shows an electron diffraction pattern corresponding to the position of a white circle in FIG. 18A.

It was observed that the electron diffraction pattern in FIG. 18B included <211> incidence from the ratio between the distance between the transmission electron spot and a diffraction spot and the distance between the transmission electron spot and another diffraction spot and the angle formed by the straight lines connecting the transmission electron spot and the diffraction spots. Furthermore, the electron diffraction pattern in FIG. 18B was confirmed to have diffraction patterns including <211> incidence because the observed rectangle diffraction patterns are rotated 60°.

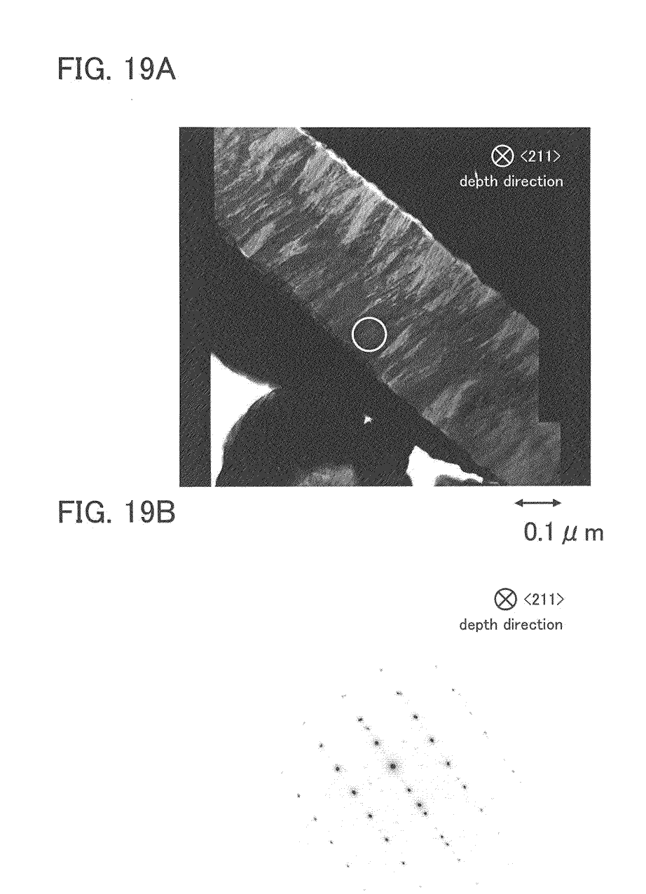

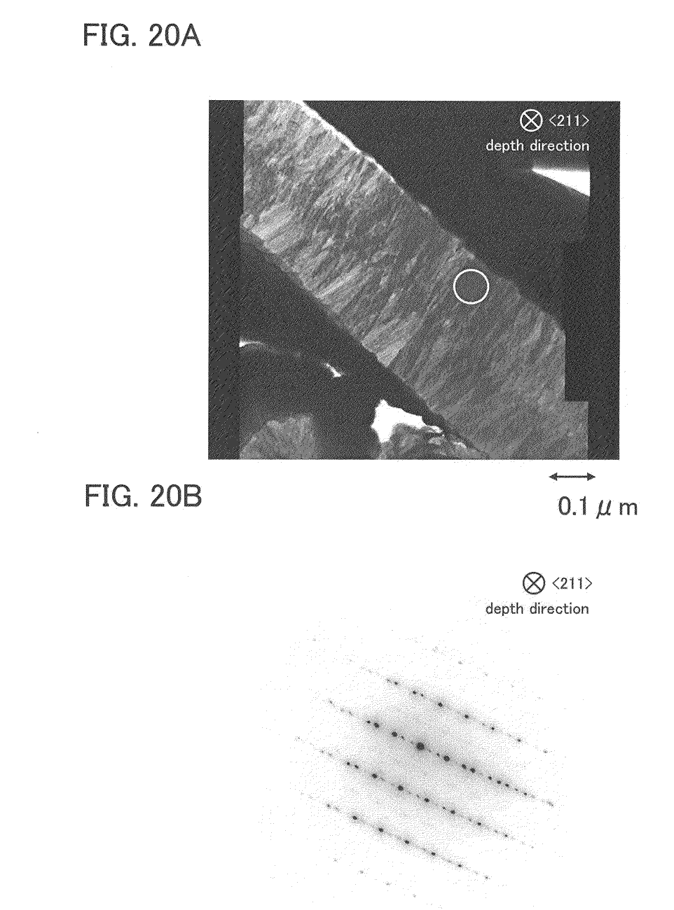

FIG. 19A and FIG. 20A are cross-sectional TEM images of the silicon crystal body that was an observation sample and was observed at different inclination angles in the range of −15° to +15°. FIG. 19B and FIG. 20B show electron diffraction patterns corresponding to the positions of white circles in FIG. 19A and FIG. 20A.

FIG. 19A and FIG. 20A show that the contrast density (hue) in the cross-sectional TEM images of the silicon crystal body is ununiformly changed when the observation at the different inclination angles was performed. In cross-sectional TEM images of single crystal silicon, the contrast density of the whole image is uniformly changed with change in inclination angle. The observation confirmed that the silicon crystal body which was the columnar protrusion was also not a single crystal but included a plurality of crystalline regions having substantially the same crystal orientation.

The electron diffraction patterns shown in FIG. 19B and FIG. 20B were each confirmed to be a diffraction pattern including <211> incidence from the ratio between the distance between the transmission electron spot and a diffraction spot and the distance between the transmission electron spot and another diffraction spot, and the angle formed by the straight lines connecting the transmission electron spot and the diffraction spots. Furthermore, indexation of the diffraction patterns confirmed that the angle formed by <111> shown in FIG. 19B and FIG. 20B and the extension direction of the silicon crystal body which was the columnar protrusion was about 15°. Thus, as described in Embodiment 1, the longitudinal direction of the silicon crystal body that was the columnar protrusion which makes an angle of about 15° with <111> was confirmed to be substantially the same as the direction obtained by projecting <211> which is regarded as a rotation axis from FIG. 18B.

In other words, the extension direction of the silicon crystal body which was the columnar protrusion was confirmed to be substantially the same as <211> that is a preferred orientation of the plurality of crystalline regions including the columnar protrusion.

### (Manufacturing Process of Lithium Ion Secondary Battery)

A manufacturing process of the lithium ion secondary battery of this example will be described.

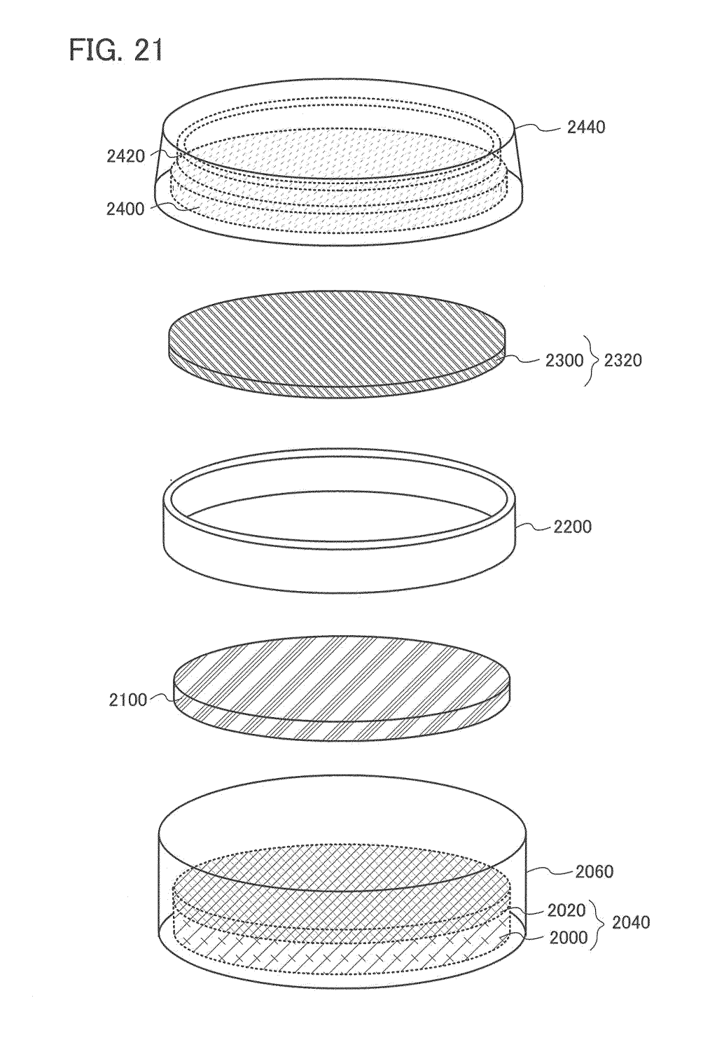

In the manner described above, the active material layer was formed over the current corrector, so that the electrode was formed. The lithium ion secondary battery was manufactured using the electrode obtained. Here, a coin-type lithium ion secondary battery was manufactured. A manufacturing method of the coin-type lithium ion secondary battery will be described with reference to FIG. 21.

As illustrated in FIG. 21, the coin-type lithium ion secondary battery includes an electrode 2040, a reference electrode 2320, a separator 2100, an electrolyte (not illustrated), a housing 2060, and a housing 2440. Besides, the coin-type lithium ion secondary battery includes a ring-shaped insulator 2200, a spacer 2400, and a washer 2420. As the electrode 2040, an electrode formed by the above process in which a positive electrode active material layer 2020 is provided over a current collector 2000 was used. The reference electrode 2320 includes a reference electrode active material layer 2300. The reference electrode active material layer 2300 was formed using lithium metal (a lithium foil). The separator 2100 was formed using polypropylene. The housing 2060, the housing 2440, the spacer 2400, and the washer 2420 each of which was made using stainless steel (SUS) were used. The housing 2060 and the housing 2440 have a function of making external electrical connection of the electrode 2040 and the reference electrode 2320.

The electrode 2040, the reference electrode 2320, and the separator 2100 were soaked in the electrolyte solution. Then, as illustrated in FIG. 21, the housing 2060, the electrode 2040, the separator 2100, the ring-shaped insulator 2200, the reference electrode 2320, the spacer 2400, the washer 2420, and the housing 2440 were stacked in this order so that the housing 2060 was positioned at the bottom of the stacked components. The housing 2060 and the housing 2440 were pressed and crimped to each other with a “coin cell crimper”. In such a manner, the coin-type lithium ion secondary battery was formed.

As the electrolyte solution, a solution in which LiPF₆ was dissolved in a mixed solvent of EC and DEC was used.

### (Manufacturing Process of Comparative Secondary Battery)

Next, a manufacturing process of an electrode of the comparative secondary battery will be described. A manufacturing process of an electrode active material layer of the comparative secondary battery is different from that of the lithium ion secondary battery. The other structures of the comparative secondary battery are the same as those of the lithium ion secondary battery; therefore, description of structures of a substrate, an electrode current collector, and the like is omitted.

The active material layer of the comparative secondary battery was formed using crystalline silicon.

Amorphous silicon was deposited by a plasma CVD method over a titanium film which was the current collector, and heating treatment was performed, so that crystalline silicon was formed. The deposition of the amorphous silicon by the plasma CVD method was performed under the following condition: silane and 5 vol % phosphine (diluted with hydrogen) were introduced as source gases into a reaction chamber with flow rates of 60 sccm and 20 sccm, respectively; the pressure of the reaction chamber was 133 Pa; the temperature of the substrate was 280° C.; the RF power source frequency was 60 MHz; the pulse frequency of the RF power source was 20 kHz; the duty ratio of the pulse was 70%; and the power of the RF power source was 100 W. The thickness of the amorphous silicon was 3 μm.

After that, heat treatment at 700° C. was performed. The heat treatment was performed in an Ar atmosphere for six hours. By this heat treatment, the amorphous silicon was crystallized, so that a crystalline silicon layer was formed. The thus obtained crystalline silicon layer was used as the active material layer of the comparative secondary battery. Note that phosphorus (an impurity element imparting n-type conductivity) was added to this crystalline silicon layer.

### (Manufacturing Process of Comparative Secondary Battery)

A manufacturing process of the comparative secondary battery will be described.

In the manner described above, the active material layer was formed over the current collector, so that the electrode of the comparative secondary battery was formed. The comparative secondary battery was manufactured using the electrode. The comparative secondary battery was manufactured in a manner similar to that of the above lithium ion secondary battery.

### (Characteristics of Lithium Ion Secondary Battery and Comparative Secondary Battery)

Discharge capacities of the lithium ion secondary battery and the comparative secondary battery were measured using a charge-discharge measuring instrument. For the measurement of charge and discharge, a constant current mode was employed, and charge and discharge were performed with a current of 2.0 mA at a rate of approximately 0.2 C, with the upper limit voltage of 1.0 V and the lower limit voltage of 0.03 V. The measurement was performed at room temperature.

The initial characteristics of the lithium ion secondary battery and the comparative secondary battery are shown in Table 1. Table 1 shows the initial characteristics of the capacity per unit volume (mAh/cm³) of the active material layers. Here, the capacity (mAh/cm³) was calculated under the conditions where the thickness of the active material layer of the lithium ion secondary battery was 3.5 μm and that of the comparative secondary battery was 3.0 μm. Note that the capacity given here is discharge capacity of lithium.

TABLE 1

| | Capacity (mAh/cm³) |
|---|---|
| Lithium ion secondary battery | 7300 |
| Comparative secondary battery | 4050 |

As shown in Table 1, the capacity (7300 mAh/cm³) of the lithium ion secondary battery is approximately 1.8 times as large as the capacity (4050 mAh/cm³) of the comparative secondary battery.

As described above, the extension directions of the needle-like protrusions or the columnar protrusions in the active material layer of the lithium ion secondary battery may vary; thus, there are spaces among the protrusions. Thus, actual capacity of the lithium ion secondary battery may be higher than the value shown in Table 1.

From the above, the actual capacity of the lithium ion secondary battery of this example is close to the theoretical capacity (9800 mAh/cm³) of the lithium ion secondary battery. In the manner described above, by using the crystalline silicon layer formed using the LPCVD method as the active material layer, the lithium ion secondary battery with higher capacity that is close to the theoretical capacity can be manufactured.

This application is based on Japanese Patent Application serial no. 2010-159663 filed with Japan Patent Office on Jul. 14, 2010, the entire contents of which are hereby incorporated by reference.

What is claimed is:

1. A silicon crystal body comprising:
a plurality of crystalline regions,
wherein the silicon crystal body has one extension direction,
wherein the plurality of crystalline regions have substantially the same crystal orientation, and
wherein the extension direction and the crystal orientation are substantially the same.

2. The silicon crystal body according to claim 1, wherein the crystal orientation is <110>.

3. The silicon crystal body according to claim 1, wherein the crystal orientation is <211>.

4. The silicon crystal body according to claim 1, wherein the crystal orientation is the same as the extension direction when an angle formed by the crystal orientation and the extension direction is in the range of greater than or equal to 0° and less than or equal to 20°.

5. The silicon crystal body according to claim 1, wherein the silicon crystal body is cylindrical or prismatic.

6. The silicon crystal body according to claim 1, wherein the silicon crystal body is conical or pyramidal.

7. A power storage device comprising:
a pair of electrodes;
a separator; and
an electrolyte,
wherein one of the pair of electrodes is formed using a silicon crystal body including a plurality of crystalline regions,
wherein the silicon crystal body has one extension direction,
wherein the plurality of crystalline regions have substantially the same crystal orientation, and
wherein the extension direction and the crystal orientation were substantially the same.

8. The power storage device according to claim 7, wherein the crystal orientation is <110>.

9. The power storage device according to claim 7, wherein the crystal orientation is <211>.

10. The power storage device according to claim 7, wherein the crystal orientation is the same as the extension direction when an angle formed by the crystal orientation and the extension direction is in the range of greater than or equal to 0° and less than or equal to 20°.

11. The silicon crystal body according to claim 7, wherein the silicon crystal body is cylindrical or prismatic.

12. The silicon crystal body according to claim 7, wherein the silicon crystal body is conical or pyramidal.
